(19) United States
(12) Patent Application Publication
(10) Pub. No.: US 2026/0043693 A1
(43) Pub. Date: Feb. 12, 2026

(54) FORCE SENSOR ARCHITECTURES

(71) Applicant: Infineon Technologies AG, Neubiberg (DE)

(72) Inventors: Udo Ausserlechner, Villach (AT); Manuel Gillinger, Steindorf Am Ossiacher See (AT)

(21) Appl. No.: 18/796,512

(22) Filed: Aug. 7, 2024

(51) Int. Cl. G01L 1/16

(52) U.S. Cl. CPC G01L 1/16

(57) ABSTRACT

The described techniques are directed to a force sensor package that includes a force sensor and a temperature sensor combined in a monolithic integrated circuit. The force sensor package may also include other components, such as a memory and onboard processing circuitry (e.g. a microcontroller), which allows for temperature compensation to be performed on the force measurement signals generated by the force sensor. Force sensors are also described that include an integrated deformation body, such as a planar spring. Various types of deformation bodies are described, to which a force sensor chip is coupled. The structure and coupling between the force sensor chip and the deformation body facilitates the generation of stresses in two orthogonal directions in the force sensor chip having different values in response to an applied force.

### TECHNICAL FIELD

The aspects described herein generally relate to force sensors and, more particularly, to force sensor packages and various architectures thereof.

### BACKGROUND

Force sensors may be used for various applications such as those used in the automotive industry, for example, to measure braking force. However, conventional force sensors implement sensor elements such as strain gauges, which are physically small and thus difficult to mount to a deformation body to measure an applied force. The mounting of the force sensor elements also presents significant difficulty, as asymmetry between sensor elements may magnify errors in the measured force, and the material to which the sensor elements are mounted needs to be carefully considered to ensure that the measured stress/strain is due to an applied force. For example, conventional force sensors are impacted by changes in temperature, as the various sensor components may have different coefficients of thermal expansion and thus expand at different rates, thereby introducing an extraneous strain that may cause errors in the force measurement. Thus, conventional force sensors have various drawbacks with respect to their implementation and use.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1A illustrates an example first force sensor package architecture, in accordance with an embodiment of the disclosure;

FIG. 1B illustrates an example second force sensor package architecture, in accordance with an embodiment of the disclosure;

FIG. 2 illustrates an example output of the force sensor package that measures an applied force, in accordance with an embodiment of the disclosure;

FIG. 3 illustrates an example physical mechanical interface between a force sensor package and a deformation body, in accordance with an embodiment of the disclosure;

FIGS. 4A-4C illustrate examples of an electrical interface between a force sensor package and an external device, in accordance with an embodiment of the disclosure;

FIG. 5A illustrates a first view of a portion of an example force sensor package, in accordance with an embodiment of the disclosure;

FIG. 5B illustrates a second view of a portion of an example force sensor package, in accordance with an embodiment of the disclosure;

FIG. 6A illustrates an example block diagram of a force sensor chip including an electronic circuit and external connections, in accordance with an embodiment of the disclosure;

FIG. 6B illustrates an example electronic circuit comprising PMOS force sensor elements, in accordance with an embodiment of the disclosure;

FIG. 6C illustrates an example electronic circuit comprising NMOS force sensor elements, in accordance with an embodiment of the disclosure;

FIG. 6D illustrates additional detail with respect to the orientation of the stress sensor elements as shown in FIGS. 6B and 6C, in accordance with an embodiment of the disclosure;

FIG. 7 illustrates an example resulting deformation of a deformation body in response to a force applied normal to the surface of a force sensor chip, in accordance with an embodiment of the disclosure;

FIG. 8 illustrates an example finite element (FEM) numerical simulation showing a stability of in-plane stress components, in accordance with an embodiment of the disclosure;

FIG. 9 illustrates an example deformation body captivation, in accordance with an embodiment of the disclosure;

FIG. 10 illustrates a deformation plot of a force sensor package due to thermally-induced stress resulting from captivation of the deformation body at each corner;

FIG. 11 illustrates shear stress on the surface of a force sensor chip caused by the thermally-induced stress as shown in FIG. 10;

FIG. 12 illustrates an example of bond wire routing and placement for a force sensor chip, in accordance with an embodiment of the disclosure;

FIGS. 13A-13C illustrate alternative deformation body shapes, in accordance with an embodiment of the disclosure;

FIG. 14A illustrates an H-shaped deformation body, in accordance with an embodiment of the disclosure;

FIG. 14B illustrates an example resulting deformation of the H-shaped deformation body as shown in FIG. 14A in response to a force applied normal to the surface of a force sensor chip, in accordance with an embodiment of the disclosure;

FIG. 14C illustrates an alternate H-shaped deformation body, in accordance with an embodiment of the disclosure;

FIG. 15 illustrates an alternative deformation body shape and force sensor package structure, in accordance with an embodiment of the disclosure;

FIGS. 16A-16B illustrates an alternative deformation body shape and force sensor package structure, in accordance with an embodiment of the disclosure;

FIG. 17 illustrates an example configuration in which a force sensor chip is mounted to a PCB disposed between the force sensor chip and the deformation body, in accordance with an embodiment of the disclosure;

FIG. 18 illustrates an alternate U-shaped deformation body, in accordance with an embodiment of the disclosure;

FIG. 19 illustrates an example resulting deformation of the U-shaped deformation body as shown in FIG. 18 in response to a force applied normal to the surface of a force sensor chip, in accordance with an embodiment of the disclosure; and

FIG. 20 illustrates an example configuration in which a force sensor chip is encapsulated as part of a force sensor package, in accordance with an embodiment of the disclosure.

The example aspects of the present disclosure will be described with reference to the accompanying drawings. The drawing in which an element first appears is typically indicated by the leftmost digit(s) in the corresponding reference number.

### SUMMARY

Again, applications such as the automotive industry may implement force sensors or other sensors, particularly for braking systems or other subsystems that may be critical to driving safety. Conventionally, the oil pressure of a hydraulic braking system may be measured to determine an applied force, thereby verifying the proper operation of the braking system. For instance, such hydraulic braking systems may utilize a brake booster in which a sensor is placed within a reservoir to monitor the level of the hydraulic fluid, which is to detect a leakage in the system.

However, as vehicles are driven towards more electrical in their operation, established pure mechanical parts of the brake system will be replaced with electro-mechanical braking (EMB) components. Such EMB systems may use a braking system in which a motor pushes a shaft to actuate the brake discs. These newer EMB systems are only electrically connected to the brake saddle, obviating the use of the hydraulic fluid. To date, a specific force sensor for this application does not exist, and thus the embodiments described herein enable, as one application example, a force sensor to be directly mounted on the brake saddle or other location such that the force sensor measures a force due to the deformation of the object to which is it coupled.

Furthermore, the embodiments described in Section II may implement a force sensor package that implements an integrated deformation body, such as a planar spring, for instance, having a specific geometry. Thus, the force sensor package as described in Section II implements various geometries of a deformation body that is integral to the force sensor package, which enables the measurement of either in-plane shear stress (sigXY) or the difference of in-plane normal stress components (sigXX−sigYY) caused by an applied force. Additionally, the deformation body may be captivated within the sensor package in a specific manner, and the sensor elements may be located at the center of this deformation body and wire bonded in a specific way that leverages the geometry of the deformation body. The clamping of the deformation body and the load/force application is also done in a manner that allows for an improved encapsulation of the sensor elements.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

The embodiments herein are presented in two separate Sections for ease of explanation. Section I is directed to the use of a force sensor package that includes a force sensor and a temperature sensor combined in a monolithic integrated circuit. The force sensor package may also include other components, such as a memory and onboard processing circuitry (e.g. a microcontroller), which allows for temperature compensation to be performed on the force measurement signals generated by the force sensor. Section II is directed to a force sensor package that includes an integrated deformation body, such as a planar spring, for example. The force sensor package as discussed in Section II may utilize different types of uniquely-shaped deformation bodies, to which a force sensor chip is coupled. The structure and coupling between the force sensor chip and the deformation body facilitates the generation of normal stresses in two orthogonal directions in the force sensor chip having different values in response to an applied force that is normal to the surface of the force sensor chip. Additionally, the manner in which the force sensor package is constructed, as well as the coupling arrangement between the deformation body and the force sensor chip, allows for a reduction in the number of sensor elements and provides for a variety of mounting options. The shape of the deformation body may also facilitate the coupling of bond wires to the force sensor chip that are particularly short, thereby simplifying manufacturing design and reducing costs.

Although the embodiments of the force sensor package are discussed separately in each Section, it is noted that any of the embodiments described in either Section I or Section II may be combined with one another, and any of the architectures, deformation bodies, sensor elements, force sensor chips, and/or techniques described in Section I are also applicable to the embodiments described in Section II, and vice-versa. For example, any of the embodiments as described herein with respect to the force sensor package Section I may optionally be implemented as any suitable part of the force sensor package embodiments as described in Section II.

I. A Monolithic Force Sensor Package with Temperature Adjustment

Again, existing force sensors rely upon changes in a mechanical deformation body to measure an applied force. For example, an applied force may push a steel membrane down, resulting in a strain near the anchor of the membrane. However, this strain is typically measured at four positions in a Wheatstone bridge configuration, complicating its design and use. Thus, the embodiments as discussed in this Section are directed to an integrated force sensor package that may provide additional functionality compared to conventional force sensors while facilitating an easier mounting procedure given its monolithic design. The force sensor package may comprise a force sensor chip, which may be mounted directly to a deformation body, such as a brake saddle, for example, depending where the strain should be measured. The force sensor package may include one or more force sensor elements, which may be implemented as any suitable type of material having an electrical parameter that changes in response to an applied force.

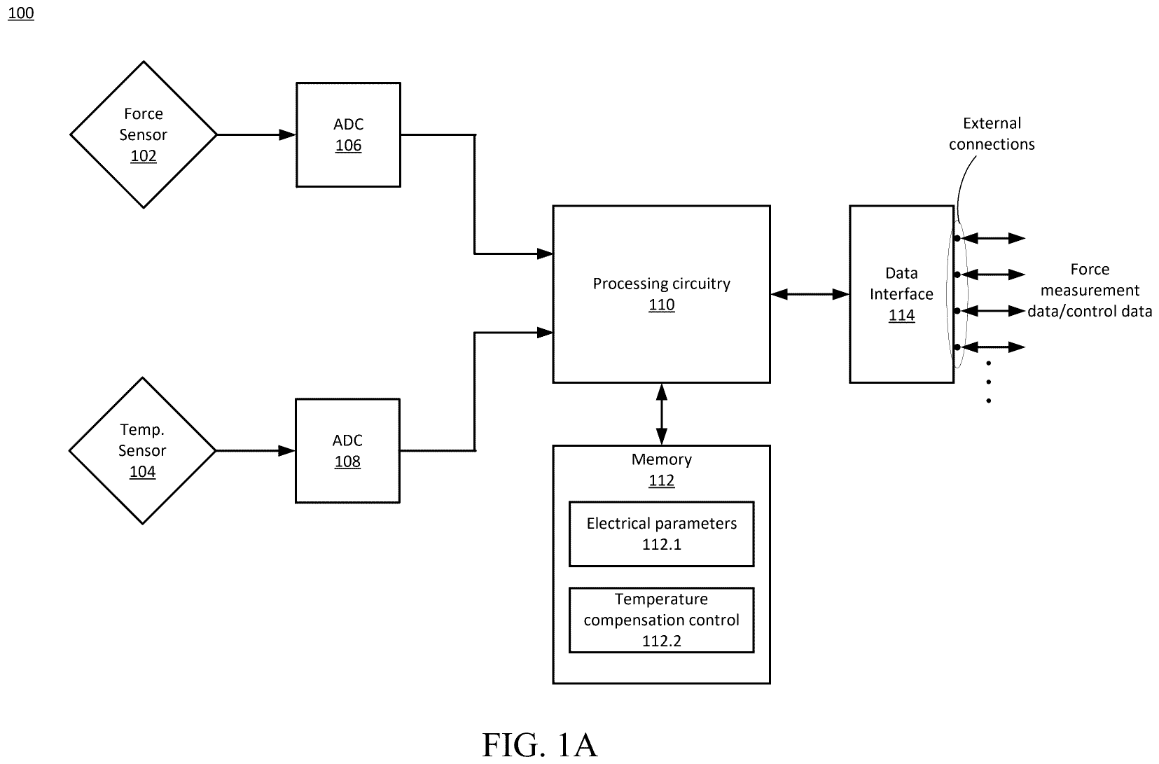

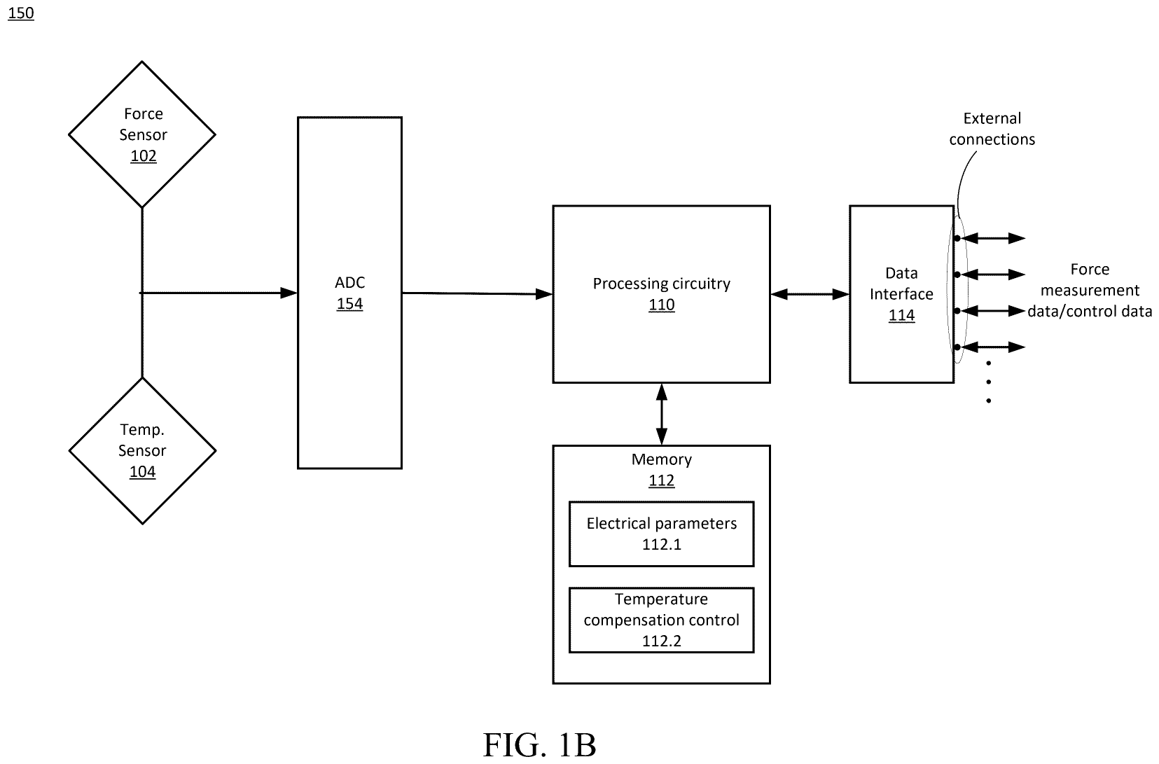

FIG. 1A illustrates an example first force sensor package architecture, in accordance with an embodiment of the disclosure. The force sensor package 100 as shown in FIG. 1A includes a force sensor 102 (e.g. a force sensor element as discussed in further detail herein), a temperature sensor 104, analog-to-digital converters (ADCs) 106, 108, processing circuitry 110, a memory 112, and a data interface 114. FIG. 1B illustrates an example second force sensor package architecture, in accordance with an embodiment of the disclosure. The force sensor packages 100, 150 as shown in FIGS. 1A and 1B, respectively, are identical to one another with the exception of the use of the ADCs 106, 108, 154. Thus, any of the statements described with respect to the force sensor package of FIG. 1A also applies to the force sensor package of FIG. 1B, and vice-versa, with the differences between these force sensor packages being noted further herein.

The force sensor package 100 may be implemented as a monolithic integrated circuit that includes additional, fewer, or alternate components as those shown in FIG. 1A. The force sensor package 100 may thus comprise a monolithic application specific integrated circuit (ASIC) for instance. The force sensor package 100 may alternatively be referred to as a force sensor chip. As discussed in further detail below, the force sensor package 100 is configured to perform temperature compensation of the measurements provided by the force sensor 102 using the temperature measurements provided by the temperature sensor 104. Moreover, the arrows shown in FIG. 1A may represent any suitable number and/or type of connections between the various components of the force sensor package 100, which may include buses, wires, conductive traces, etc.

The force sensor package 100 as shown in FIG. 1A comprises a force sensor 102. The force sensor 102 may comprise any suitable type of force sensor, including known types. The force sensor may alternatively be referred to herein as a strain sensor, a stress sensor, or a strain/stress sensor. In this context, it is understood that it is assumed that Young's modulus, which is a mechanical property of solid materials that measures the tensile or compressive stiffness when a force is applied lengthwise, is a predetermined parameter that is known with respect to the operation of the force sensor package 100. For example, the Young's modulus of the force sensor package 100 may be known from the materials on which the force sensor package 100 is disposed or derived from experimental tests in advance of the operation of the force sensor package 100.

In any event, the force sensor 102 may be configured to generate a force measurement signal resulting from a strain that is transferred to the sensor package as a result of a deformation of the object due to an applied force. However, the force sensor 102 may additionally or alternatively generate a force measurement signal resulting from a stress that is transferred to the sensor package as a result of a deformation of the object due to an applied force, with the understanding that the relationship between stress and strain is the known Young's modulus constant for the force sensor package 100 as described above.

The force sensor 102 may be implemented with any suitable number and/or type of strain or stress elements configured to measure strain and/or stress, including known types, with the measured strain or stress being output as a corresponding force measurement signal in either case. For example, the force sensor 102 may be implemented as a one or more resistors, transistors, or xMR-based sensor elements that output a force measurement signal that is indicative of a strain and/or stress that results from an applied force. To provide additional examples, the force sensor 102 may be implemented as a metal oxide semiconductor field effect transistor (MOSFET) current mirror, which may include two or more orthogonal PMOS or NMOS elements that deliver a current that is a function of stresses applied in one or more directions as a result of an applied force. The strain and/or stress that is induced into the force sensor element 102 and measured as the force measurement signal is a result of the applied force causing a deformation of a deformation body to which the force sensor package 100 is coupled, as further discussed herein. In the example of a EMB system as noted above, the deformation body may a brake saddle that is deformed upon braking, although the embodiments are not limited to such applications or specific types of deformation bodies.

With continued reference to FIG. 1A, the force measurement signal is output by the force sensor 102 as an analog voltage or current value, which may be within any suitable range of values depending upon the particular application. The force sensor 102 is configured to generate the force measurement signal continuously or in accordance with any suitable sampling rate of measurement, and thus the force sensor package 100 may output the force measurement data as discussed herein in each case. The force measurement signal output by the force sensor 102 is coupled to an analog-to-digital converter (ADC) 106. The ADC 106 may comprise an ADC having any suitable resolution, which is configured to transform the analog force measurement signal to a digital value comprising any suitable number of bits. The digital force measurement signal is then coupled to the processing circuitry 110 for further processing, as discussed in further detail below.

The temperature sensor 104 may be disposed within the force sensor package 100 proximate to the force sensor 102 and thus the temperature measurement signal may be indicative of a measured temperature of a region of the force sensor package 100 that is also proximate to the force sensor 102. The temperature sensor 104 may be implemented with any suitable number and/or type of temperature sensor elements and/or accompanying circuitry to generate a temperature measurement signal that is indicative of a measured temperature. For example, the temperature sensor 104 may include one or more Negative Temperature Coefficient (NTC) thermistors, one or more Resistance Temperature Detectors (RTDs), the PN junction of a bipolar transistor, one or more thermocouples, one or more semiconductor-based sensors (e.g. utilizing identical diodes with temperature-sensitive voltage vs current characteristics), etc.

The temperature measurement signal is output by the temperature sensor 104 as an analog voltage or current value, which may be within any suitable range of values depending upon the particular application. The temperature measurement signal output by the temperature sensor 104 is coupled to an analog-to-digital converter (ADC) 108. The ADC 108 may comprise an ADC having any suitable resolution, and is configured to transform the analog temperature measurement signal to a digital value comprising any suitable number of bits. The ADC 108 may be identical to the ADC 106 or, alternatively, the ADCs 106, 108 may operate using different bit resolutions, different reference voltages and/or currents, or otherwise differ in their configuration and/or operation. The digital temperature measurement signal is then coupled to the processing circuitry 110 for further processing, as discussed in further detail below.

Referring now to FIG. 1B, the force sensor package 150 includes a single ADC 154 instead of the separate ADCs 106, 108 as shown in FIG. 1A. For the force sensor package 150, the ADC 154 may operate in the same manner with respect to the digitation of the received force measurement signal and the temperature measurement signal. However, for the force sensor package 150, the ADC 154 is common to the force sensor 102 and the temperature sensor 104. Thus, the ADC 154 may receive the force measurement signal and the temperature measurement signal at different times, sharing a common connection between the force sensor 102 and the temperature sensor 104. This may be implemented, for instance, using a time-division multiplexing (TDM) of the received force measurement signal and the temperature measurement signal. The sampling rate and period of each of the force measurement signal and the temperature measurement signal output by the force sensor 102 and the temperature sensor 104 may, for example, be in accordance with a predetermined asynchronous timing schedule or synchronized with one another in response to any suitable clock signal (not shown).

The processing circuitry 110 may be implemented as any suitable number and/or type of components configured to execute machine-readable instructions, perform processing operations, or otherwise perform the various functions as discussed herein. To do so, the processing circuitry 110 may be implemented, for example, as one or more processors and/or cores, as any suitable number and/or type of dedicated hardware components such as a microcontroller, an application specific integrated circuit (ASIC), a field programmable gate array (FPGA), a system on a chip (SoC), dedicated logic and/or other circuitry, etc.

The memory 112 may comprise any suitable type of non-transitory computer readable medium such as a volatile memory, a non-volatile memory (e.g. an electrically erasable programmable read only memory (EEPROM)), or combinations of these. To the extent that the processing circuitry 110 implements software-based solutions to perform the various functions as discussed herein, this may be achieved, for instance, via the processing circuitry 110 accessing the electrical parameters 112.1 and executing instructions stored in the temperature compensation control module 112.2.

Thus, the processing circuitry 110 may execute the computer-readable instructions stored in the temperature compensation control module 112.2 to perform any of the various functions as discussed in further detail herein with respect to generating the force measurement data for the force sensor package 100. Alternatively, the processing circuitry 110 may perform the various functions as discussed in further detail herein using hardware components such as adders, bit shifters, logic components, etc. In accordance with such embodiments, the processing circuitry 110 may access electrical parameters 112.1 stored in the memory 112 to perform such operations.

Although the memory 112 is shown in FIG. 1A, this is by way of example and case of explanation. The memory 112 as shown in FIG. 1A may be integrated as part of the processing circuitry 110. Additionally or alternatively, the memory 112 may be implemented in addition to an integrated memory of the processing circuitry 110, and in such a case any of the data stored in the memory 112 may be alternatively stored in the memory that is integrated as part of the processing circuitry 110, and vice-versa.

In any event, the electrical parameters 112.1 may represent any suitable electrical parameters associated with the force sensor 102 and/or the temperature sensor 104. The processing circuitry 110 may thus utilize the electrical parameters 112.1 to generate temperature-corrected force measurement data using one or more of the stored electrical parameters, as further discussed below. For example, changes in temperature will introduce error into the force measurement signal generated by the force sensor 102 as a result of thermally-induced strain. The processing circuitry may access the electrical parameters 112.1 to compensate for this temperature error.

To do so, the electrical parameters 112.1 may represent any suitable information regarding the operating characteristics of the force sensor 104 or other components of the force sensor package 102 as a function of temperature. This information may be derived, for instance, based upon calibrated force measurements or other measurements performed at different temperatures, which may be performed prior to the operation of the force sensor package 100. For example, the electrical parameters 112.1 may include data that represents thermal operating curves of strain or stress data measurements of the force sensor 102 and/or identified strain or stress measurement offsets that correlate to respective operating temperatures. As an additional example, the electrical parameters 112.1 may include information regarding the temperature coefficient of the reference voltage used by the ADC 106 and/or the ADC 108.

In any event, the processing circuitry 110 may access the electrical parameters 112.1 to map a measured temperature to a corresponding strain or stress measurement offset value. The processing circuitry 110 may then use this strain or stress offset to compensate for the temperature error of the received digital force measurement signal. Additionally, the processing circuitry 110 may utilize the temperature coefficients of the reference voltage used by the ADC 106 to further compensate the received digital force measurement signal, which may include for instance compensating for voltage drift by offsetting the received digital force measurement signal by a digital bit value that correlates with the current temperature measurement. Thus, the processing circuitry 110 uses the temperature measurement signal, which indicates the temperature of (or at least proximate to) the force sensor 102 when the digital force measurement signal was received to generate temperature-corrected force measurement data. Again, this temperature-corrected force measurement data compensates for temperature error introduced into the force measurement signal and/or the ADC 106.

The electrical parameters 112.1 may additionally represent any suitable data that may be used to compensate the temperature measurements provided by the temperature sensor 104. For example, the electrical parameters 112.1 may include any suitable information to enable a relative change of the force measurement data to generate the temperature-corrected force measurement data. This may include, as one example, a calibration to an external reference temperature sensor and/or a system temperature. Any suitable data representing such external temperatures may thus be included as part of the electrical parameters 112.1.

In various embodiments, the processing circuitry 110 may provide digital data to the data interface 114, which is configured to output the digital data to an external device such as a microcontroller, an electronic control unit, etc. The data interface 114 may also enable the force sensor package 100 to receive data from an external device, which may comprise control and/or configuration data for instance. Thus, the data interface 114 may be implemented as any suitable number and/or type of components to facilitate the force sensor package 100 transmitting and/or receiving data from an external device as discussed herein. For example, the data interface 114 may comprise any suitable number of ports, pins, drivers, bond pads, wires, buffers, etc. In various embodiments, one or more portions of the data interface 114 may be integrated with the processing circuitry 110. Thus, the data interface 114 may comprise the internal connections within the force sensor package 100 from and/or within the processing circuitry 110 and/or the external connections (e.g. bond pads) of the force sensor device 100, or any suitable combination thereof that enables the transfer of data as noted herein.

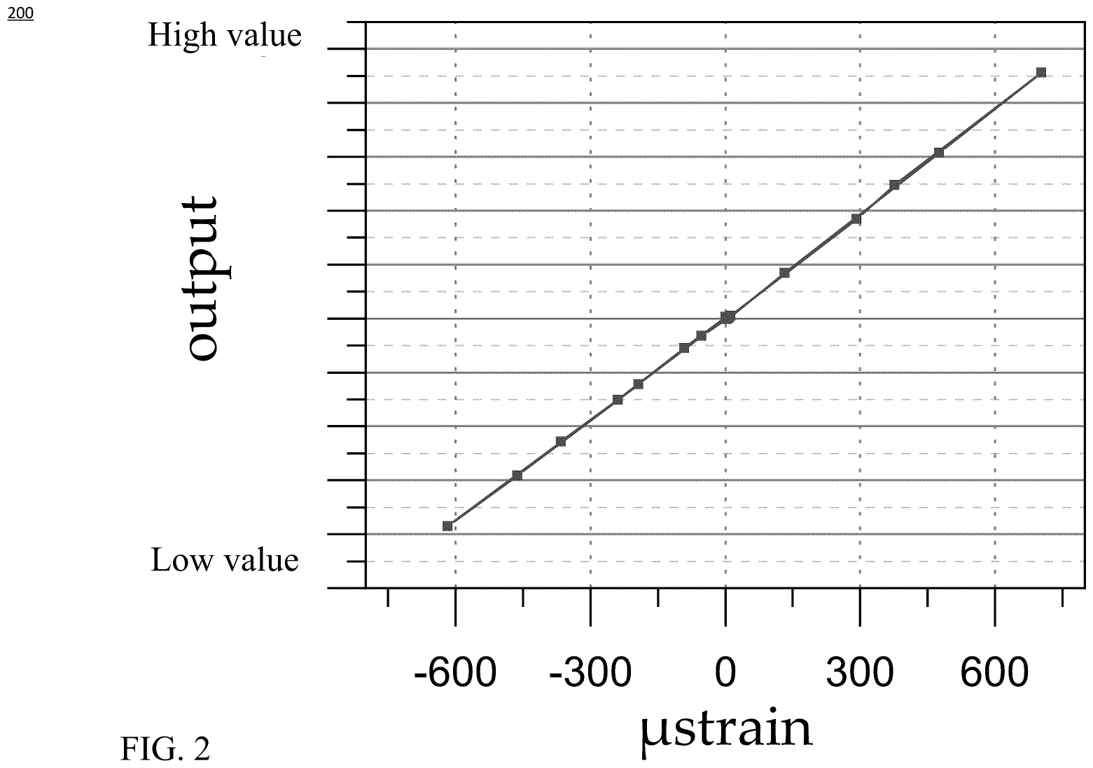

Additionally or alternatively, the data interface 114 may output the force measurement data as an analog signal. To do so, the processing circuitry 110 may comprise any suitable type of analog driver circuitry configured to output the force measurement data as an analog value (e.g. a voltage or current value), that is transmitted via the data interface 114. Additionally or alternatively, the force sensor package 150 may include any suitable number of digital-to-analog converters (DACs), which may have any suitable bit resolution. These DACs may, for example, be implemented as part of the processing circuitry 110 and/or the data interface 114, or as a separate component between the processing circuitry 110 and the data interface 114 (not shown). The force sensor package 150 may thus output, via the data interface 114, the force measurement data as a digital signal (e.g. as shown in FIG. 2) and/or as an analog signal representing these values via an analog signaling scheme.

As shown in FIG. 1A, the digital data may comprise force measurement data, which may include the temperature-corrected force measurement data as described above. Alternatively, the force measurement data may comprise data indicative of an applied force, which has been calculated by the processing circuitry 110. That is, the force measurement data may include data that indicates an applied force, which has been calculated by the processing circuitry 110 from the temperature-corrected force measurement data. Alternatively, the temperature-corrected force measurement data may be transmitted as the force measurement data, with the additional computations to convert the temperature-corrected force measurement data to the force measurement data being offloaded to the external device to determine the applied force.

To provide an illustrative example, the processing circuitry 110 may receive the digital force measurement signal from the ADC 106, which may comprise a stress or strain measurement performed by the force sensor 102 that has been digitized as noted above. The processing circuitry 110 may then perform temperature compensation on the digital force measurement signal to provide temperature corrected strain or stress data. Again, regardless of the type of sensor, the processing circuitry 110 may convert between stress and strain using Young's modulus. The processing circuitry 110 may then use, for instance, a temperature corrected strain measurement to obtain a temperature corrected stress measurement. An example of such a strain measurement is shown in FIG. 2, which maps digital values to a range of microstrain measurements. Once the stress measurement is calculated, the resulting computation may then be multiplied by the area over which the measurement was performed to convert to a force measurement (stress=Force/area). For instance, the area may correspond to the surface of the force sensor package 100 that is coupled to a deformation body. Alternatively, the temperature corrected stress or strain measurement may be generated as the force measurement data that is transmitted to an external device, which then performs the force calculation.

In either case, it is noted that given the implementation of the onboard processing circuitry 110, the entirety of the force sensor package 100 may advantageously be coupled to a deformation body. This is in contrast with the conventional practice of only mounting the force sensor 102 to the deformation body, in which case it is preferable to avoid stress and strain from being induced into other portions of the structure to which the sensor is mounted, which would otherwise introduce error. Thus, given the larger area of the force sensor package 100, this allows for an easier installation process, and this is possible via the use of the processing circuitry 110 to perform error compensation as well as the mechanical architecture of the force sensor package 100, which is discussed in further detail below.

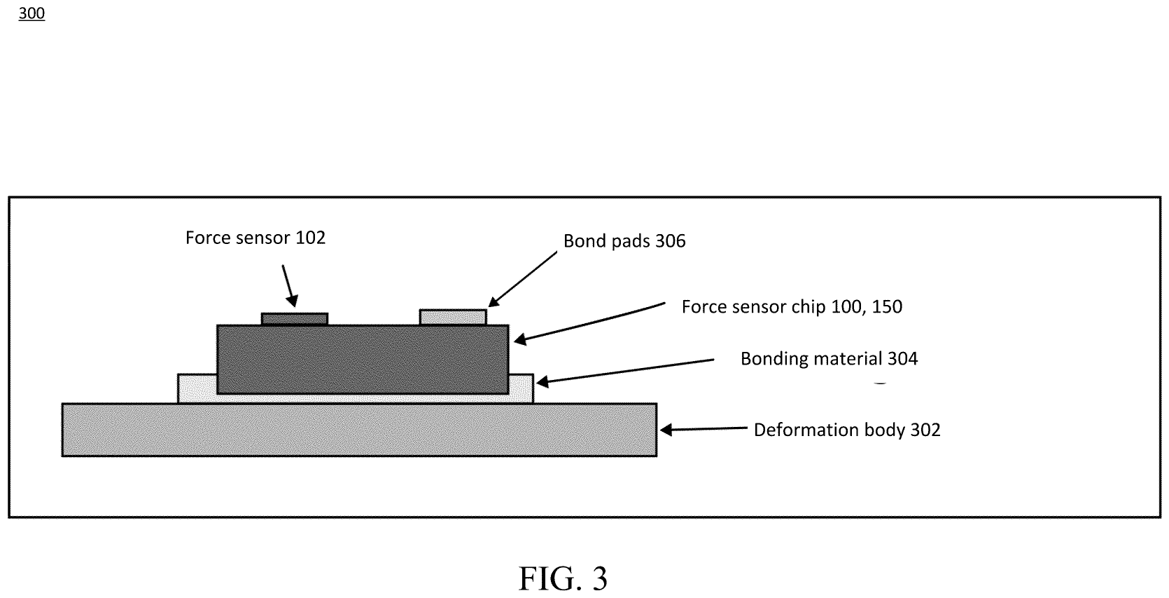

FIG. 3 illustrates an example physical mechanical interface between a force sensor package and a deformation body, in accordance with an embodiment of the disclosure. The force sensor 102 is shown in FIG. 3 for purposes of clarity, although it will be understood that the force sensor 102 is integrated within and as part of the force sensor package 100, 150. Thus, the force sensor 102 may not necessarily be physically positioned on the force sensor package 100, 150 as shown. As shown in FIG. 3, the force sensor package 100, 150 is bonded directly to a deformation body 302 via a bonding material 304. The deformation body 302 may comprise any suitable type of body that may be deformed as part of a particular application, with this deformation inducing stress and strain into the force sensor package 100, 150 and, in turn, into the force sensor 102. For instance, the deformation body may comprise a brake saddle that forms part of an EMB system as noted above.

The bonding material 304 may comprise any suitable type of material that is used in accordance with any suitable bonding process to ensure that the stress/strain resulting from the deformation of the deformation body 302 is transferred into the force sensor package 100, 150 and the force sensor 102. For instance, the force sensor package 100, 150 may be disposed onto the deformation body 302 using a bonding process such as glass fritting or a similar metallurgic process. The use of glass fritting or similar metallurgic processes are particularly useful in that these ensure a very good strain transfer from the carrier material to the force sensor package 100. This strain may then be transformed into stress, for example, which can be detected by the force sensor 102.

As an illustrative example, when force is applied to the deformation body 302, an elongation of the deformation body 302 results. This strain is transferred into the force sensor package 100, 150 via the bonding material 304. Again, the relationship between strain ε and stress σ is defined via the material-specific Young's modulus E according to σ=εE. Thus, this correlation may be used, as the Young's modulus E of the force sensor package 100, 150 may be known in advance, and thus the correlation between force and stress is also known.

FIG. 3 also illustrates the use of bond pads 306, which are disposed onto the force sensor package 100, 150 as shown. The force sensor 100, 150 may comprise any suitable number of bond pads 306, which may comprise or be electrically coupled to the data interface 114 as show in FIGS. 1A and 1B. For example, the bond pads 306 as shown in FIG. 3 may be identified with the external connections as shown in FIGS. 1A and 1B.

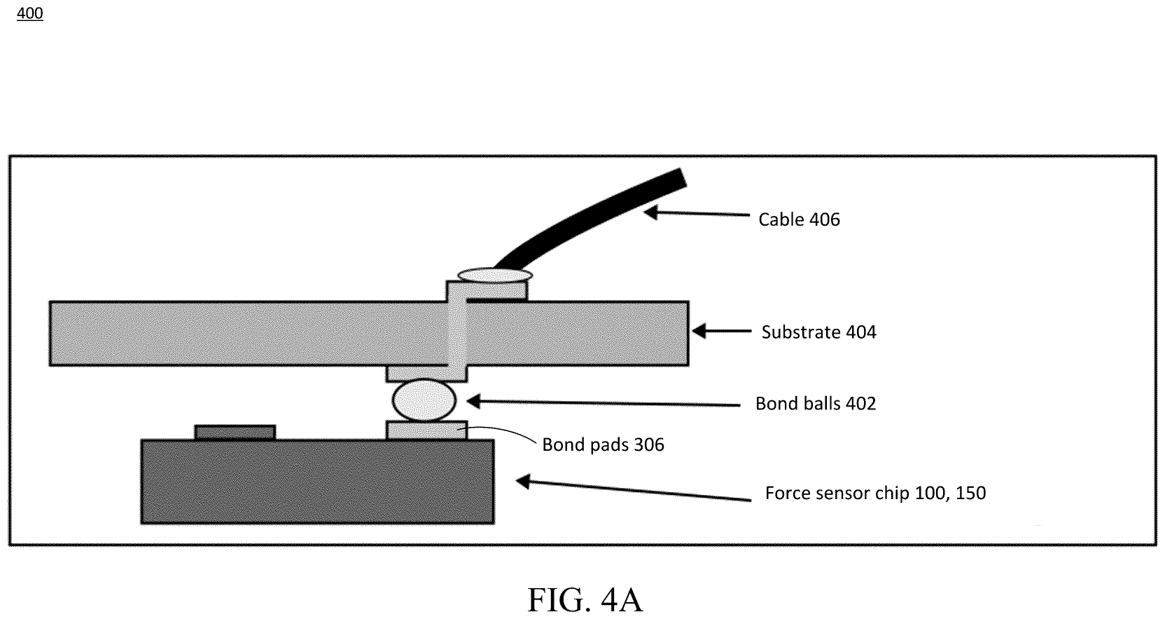

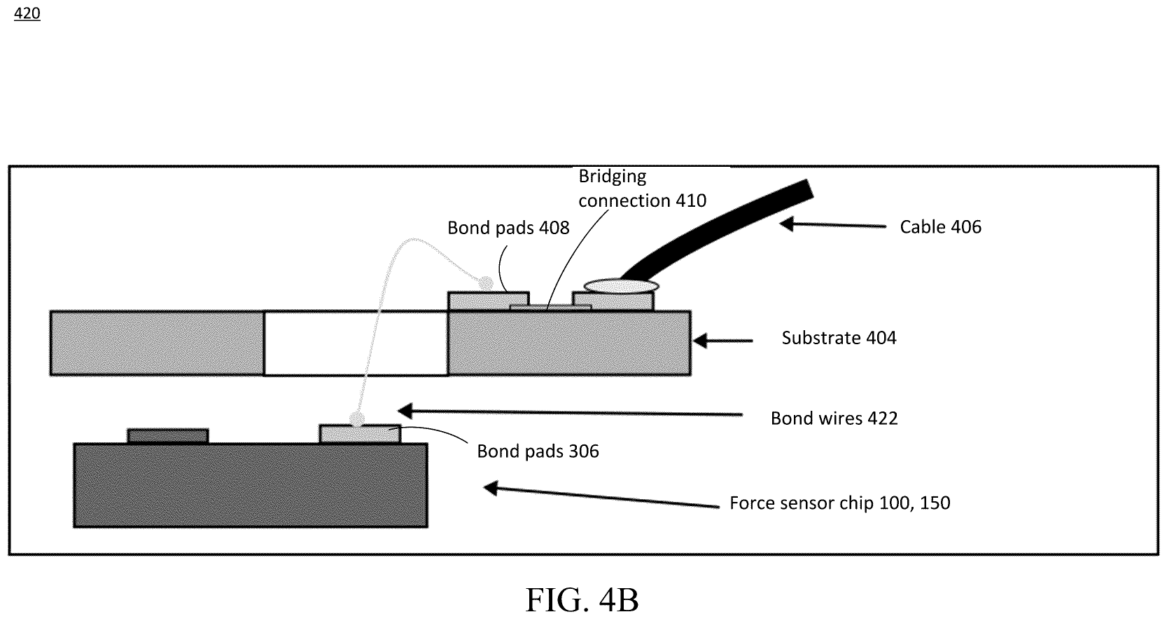

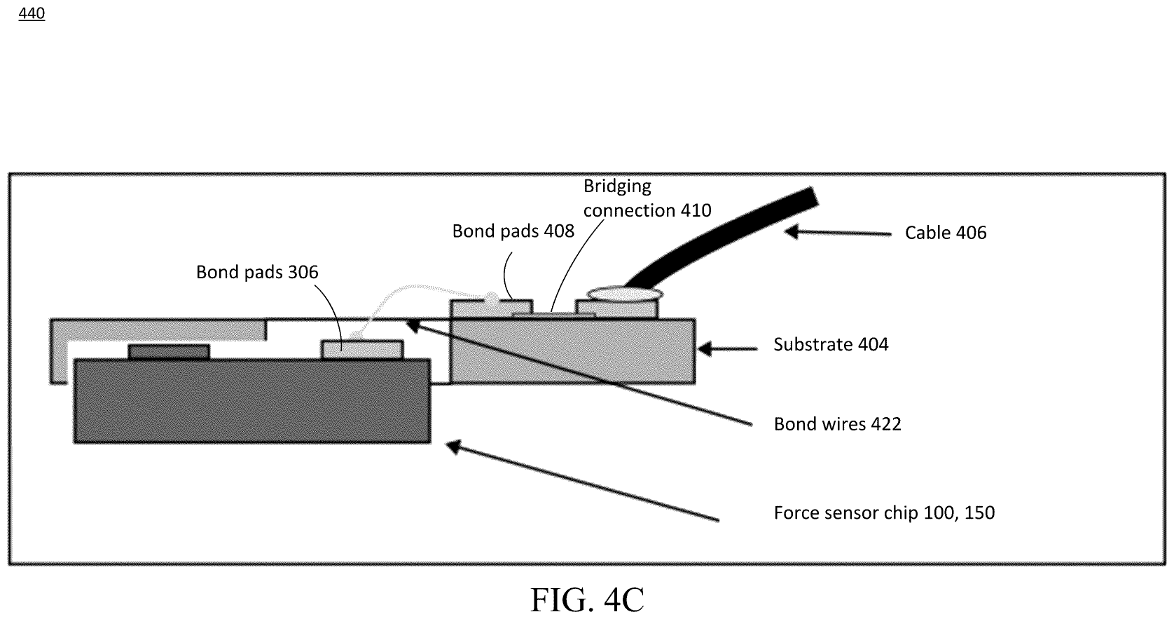

FIGS. 4A-4C illustrate examples of an electrical interface between a force sensor package and an external device, in accordance with an embodiment of the disclosure. In FIGS. 4A-4C, it is shown that the force sensor package 100, 150 may be connected to any suitable type of substrate 404, which may comprise a printed-circuit board, FR4, etc. A deformation body is not shown in FIGS. 4A-4C for purposes of clarity, but may be coupled to the force sensor package 100, 150 at the opposite side of the bond pads 306 in each case.

For example, and as shown in FIG. 4A, bond balls 402 may be used to solder or otherwise electrically couple the force sensor package 100, 150, which is then flipped and coupled directly to the substrate 404 in this manner. Thus, for this mechanical configuration, each of the bond pads 306 is coupled to the substrate 404 via one or more corresponding bond balls 402. The substrate 404 may comprise a PCB, for example, which includes one or more connections to the external computing device. In the example shown in FIG. 4A, a single cable 406 is shown, although any suitable number of such cables may be implemented for this purpose. For example, the force sensor package 100, 150 as shown in FIGS. 4A-4C may comprise an embedded wafer level ball grid array (eWLB), with the backside exposed to facilitate the bonding process as shown.

Alternatively, and as shown in FIG. 4B, the force sensor package 100, 150 may be connected to the substrate 404 via bond wires 422. For example, and as shown in FIG. 4B, the bond wires 422 may be used to electrically couple the bond pads 306 of the force sensor package 100, 150 directly to corresponding bond pads 408 of the substrate 404. Thus, each of the bond pads 306 is coupled to the substrate 404 via one or more corresponding bond wires 422, which are coupled to a corresponding bond pad 408. Each bond pad 408 is, in turn, coupled to a corresponding cable 406 via a bridging connection 410. Again, the substrate 404 may comprise a PCB, for example, which includes one or more connections to the external computing device. In the example shown in FIG. 4B, a single cable 406 is shown, although any suitable number of such cables may be implemented to electrically couple the force sensor package 100, 150 to the external device in this manner.

As another example, FIG. 4C illustrates an embodiment in which the force sensor package 100, 150 is partially embedded within the substrate 404. The electrical connections as shown in FIG. 4C are the same as those shown in FIG. 4B, although in the embodiment as shown in FIG. 4C the substrate 404 includes a hole or indentation as shown in FIG. 4C, and the force sensor package 100, 150 is inserted into the hole and thus covered by the substrate 404. Additionally, the substrate 404 may be modified such that the force sensor package 100, 150 may be embedded entirely within the substrate 404, thereby further increasing the mechanical connection between the force sensor package 100, 150 and the substrate 404.

II. A Force Sensor Package with an Integrated Deformation Body

As noted above, this Section is directed to a force sensor package that implements an integrated deformation body and addresses issues related to conventional force sensors as further described herein. However, the force sensor package in this Section may include a force sensor chip, which may comprise force sensor elements and other optional components, as well as additional components such as an integrated deformation body. Thus, the force sensor chip as described in Section I may be synonymous with a force sensor package, whereas the force sensor chip as described in Section II may, in some embodiments, be considered a portion of a force sensor package.

In any event, it is noted that conventional force sensor package designs may implement an integrated spring/deformation body, which deflects under the action of an applied force to be measured. Strain gauges may then be glued or otherwise affixed to this deformation body such that their resistance changes due to the applied strain. The strain gauges are typically connected in a Wheatstone bridge manner, which is supplied with a voltage by a circuit and its output connected to an amplifier. The small output voltage of the bridge is thus amplified and corrected for temperature drift and offset, and then output.

But, and as noted above, thermally-induced stresses may introduce errors into the force measurements, which in such designs may result from a difference in the coefficient of thermal expansion (CTE) between the strain gauge and the integrated spring. As one illustrative example, it is assumed that a strain gauge is glued to the spring at 25° C., the CTE of the spring is 15 ppm/° C., and the CTE of the strain gauge is 10 ppm/° C. At 26° C., the spring expands 5 ppm more than the strain gauge, and therefore the strain gauge seems to output a deflection of the spring, which is not existent (i.e. not due to an externally applied force to be measured). This leads to a temperature dependent zero-point error in force measurement.

Conventionally, and with reference to the above illustrative example, this error is managed by trimming the temperature coefficient of the strain gauge resistance to −5 ppm/° C., which roughly compensates for the extra 5 ppm/° C. in CTE-mismatch between the spring and strain gauge. However, the accuracy of this method is limited, and the strain-gauge resistance has to match the CTE-mismatch between the spring and the strain-gauge, i.e., for each spring material one needs a dedicated strain-gauge material or tempering procedure. In other words, the CTE of the strain gauge resistance is trimmed by a tempering procedure, not by a change in material or alloy composition.

Additionally, conventional strain gauge based force sensors require four strain gauge elements, which complicates their design and increases cost. The embodiments of the force sensor package as described in further detail in this Section may reduce the use of such sensor elements, by implementing at least two strain/stress-sensitive electronic devices. These strain/stress-sensitive electronic devices may also be referred to herein as force sensor elements, strain sensor elements, stress sensor elements, or strain/stress sensor elements. The force sensor elements form part of a force sensor chip, and respond differently to at least one strain/stress component. The integrated deformation body to which the force sensor chip is mounted may generate different in plane stress component values in different directions in response to an applied force, and force sensor elements may be arranged orthogonal to one another to exploit this feature.

The force sensor package also comprises a sensor circuit, which may alternatively be referred to herein as an electronic circuit, and which converts an electrical parameter of the force sensor elements to a force measurement signal in response to an applied force. The force sensor elements may have any suitable implementation, as discussed in further detail herein. For instance, the force sensor elements may comprise strain gauges aligned in two different directions, metal-resistors disposed on the surface of a substrate aligned in two different directions, piezo-resistors, piezo-MOSFETs (e.g. arranged in a current mirror configuration), Hall-effect devices, capacitors on a semiconductor chip aligned in two different directions, etc. The two different directions may, for example, comprise orthogonal directions, as shown in further detail in this Section.

Due to the perpendicular arrangement between the force sensor elements, the force sensor elements are configured to measure either in-plane shear stress (sigXY) or the difference of in-plane normal stress components (sigXX−sigYY) in/near a main X-Y-surface of the force sensor chip and near the center of the chip surface. To facilitate these measurements, the force sensor chip, which includes at least the force sensor elements, may be rigidly affixed (e.g. glued or otherwise bonded) to a deformation body that is included as part of the force sensor package, such as a spring for example.

As discussed in further detail in this Section, the deformation body may have a specific geometry that exploits symmetry and/or rotational symmetry, as well as other unique shapes, to provoke only sigXY or sigXX−sigYY when an applied force to be measured deflects the deformation body. Additionally, the deformation body may be clamped or otherwise affixed within the force sensor package at specific locations and be supported by a glide contact surface on the opposite side to prevent measurement errors due to thermal expansion. Furthermore, the deformation body may have recessed shapes, with the leads of the force sensor package projecting into (e.g. being routed through) these recesses to reduce the overall length of coupled bond wires. The force sensor package may comprise a lower housing and an upper housing, which may alternatively be referred to as “portions,” and which encapsulate the force sensor elements. Both of these portions may be loosely coupled to one another (in a mechanical sense) and may optionally be coupled to one another via a mechanism having a spring constant that is significantly less (e.g. 1/10, 1/100, etc.) than the spring constant of the integrated deformation body to which the force sensor chip is disposed. Such a loose coupling arrangement may be particularly useful to facilitate a snap-on type encapsulation and assembly process for the force sensor package.

### A. The Use of a Two-Dimensional Body to Prevent Temperature Induced Measurement Errors

Again, conventional force sensors may include strain gauges that are mounted to springs, and which measure an applied force by way of a deformation of the spring caused by the applied force. However, such strain gauges are typically implemented as metallic grids with long slim parallel traces, and thus their resistance increases if the long trace is elongated by a strain of the spring in the longitudinal direction. However, if the spring expands perpendicular to the longitudinal direction, the strain gauge does not respond or responds very little. This leads to an issue with respect to thermal strain, as a single strain gauge is not able to discriminate between a measured strain in the longitudinal direction due to an external force or from thermal expansion.

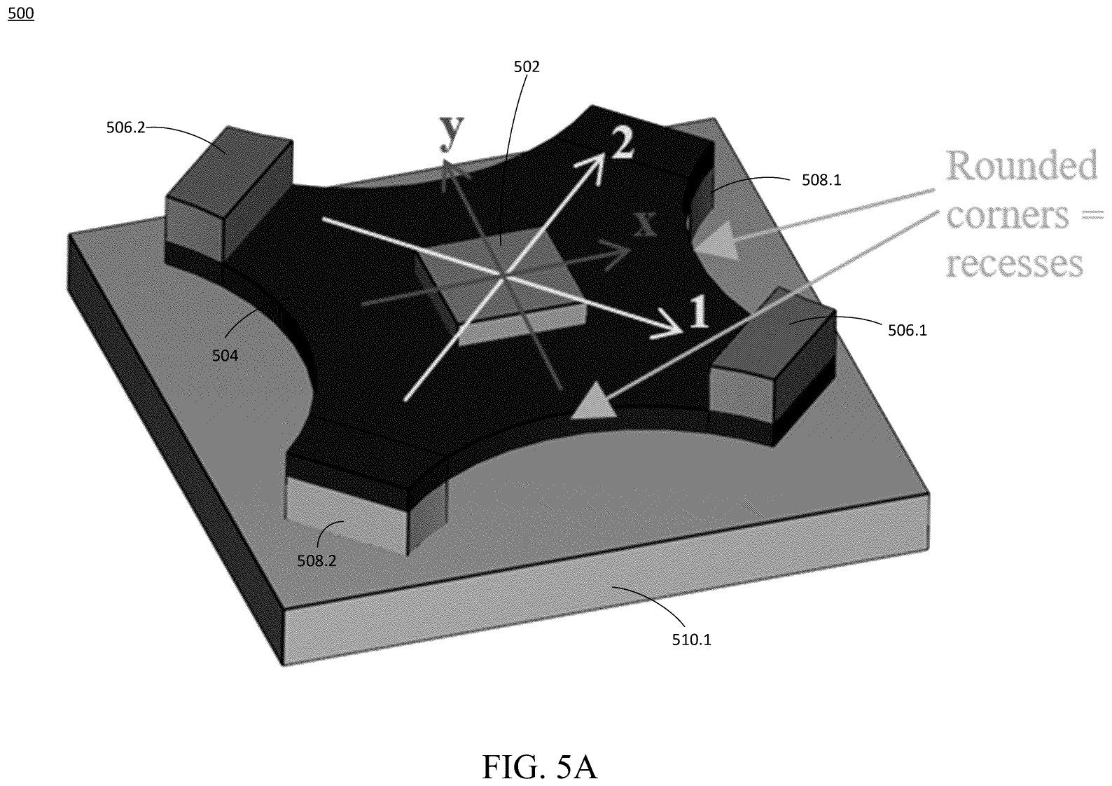

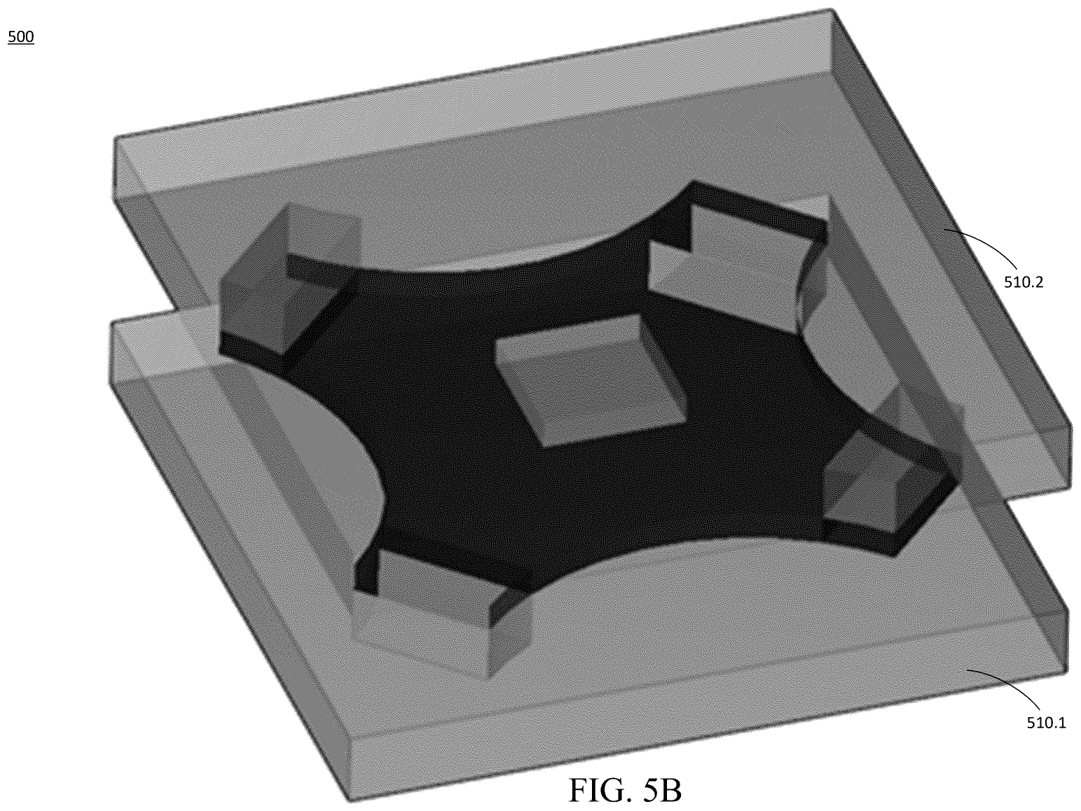

Conversely, the embodiments described in this Section are directed to the use of a two-dimensional body, referred to herein as a force sensor chip, which may also be referred to herein simply as a sensor chip and include two or more force sensor elements, which may also be referred to herein as sensor elements. The two or more force sensor elements, which are not shown in FIG. 5A but may also be disposed in the center of the force sensor chip 502, may be embedded within and/or close to the top or bottom surface of the force sensor chip 502. The force sensor chip 502 may comprise a semiconductor chip having any suitable number of components, which are discussed in further detail herein. The force sensor elements may comprise any suitable type of components, each comprising an electrical parameter that responds differently to orthogonal in-plane stress components induced into the deformation body 504 due to an applied force, which may be normal to the surface of the force sensor chip 502, as further discussed herein. To do so, the deformation body 504 may have a geometric shape and configuration such that two different normal stress values are generated in two orthogonal directions in response to an applied force. Moreover, the force sensor elements may, for example, be oriented perpendicular to one another and aligned parallel with the edges of the force sensor chip 502 so as to measure these different normal stress values. Additional details regarding the geometry and operation of the force sensor elements are provided further below.

An example of such a force sensor chip is shown in FIG. 5A, which comprises a portion of a force sensor package 500 as shown. The force sensor package 500 may include additional, fewer, or alternate components than those discussed herein. For instance, the force sensor package 500 may include the force sensor chip 502, the deformation body 504, the various supports 506, 508, the lower and upper housings 510.1, 510.2 (See FIG. 5B), as well as any other suitable components that may facilitate the full encapsulation and operation of the force sensor package 500.

For instance, the force sensor package 500 includes a force sensor chip 502 that is coupled to the center of a deformation body 504. The force sensor chip 502 may be coupled directly to the deformation body 504 in this manner using any suitable bonding techniques, such as an adhesive, a solder (soft, hard, diffusion solder), a brazing, a welding, etc., for example. The force sensor chip 502 may be attached to the deformation body 504 along a full flat main (e.g. bottom) surface of the force sensor chip 502, with the opposite (i.e. top) side of the force sensor chip 502 being shown in FIG. 5A. Alternatively, the force sensor chip 502 may be coupled to the deformation body 504 via an intermediate substrate, such as a printed circuit board for instance, which may increase the physical robustness of the force sensor package 500 to applied forces, as further discussed herein.

The deformation body 504 may comprise any suitable type of material to ensure adequate deflection and the generation of in plane stress components in response to an applied force, as discussed herein. The deformation body 504 may have any suitable thickness to ensure a desired stiffness and deformation in response to an applied force. Additionally, the deformation body 504 may have a uniform thickness or, alternatively, a variable thickness with respect to different regions. As an example, the deformation body 504 may have a central portion (e.g. where the force sensor chip 502 is disposed) that is thicker or thinner than the outer arms (e.g. where the supports 506.1, 506.2, 508.1, 508.2 are located, as discussed herein). It may be particularly useful for the deformation body 504 to be thicker at the central region to provide additional protection to the force sensor chip 502, thereby preventing breakage.

As some illustrative examples, the deformation body 504 may comprise a metal like spring-steel, bronze, CuBe, etc. As additional illustrative examples, the deformation body 504 may comprise an FR4 material, glass, a plastic/polymer/duroplast/thermoplast/resin/Kapton, ceramic, layers of glass fiber or carbon fibers, Kevlar, etc. To provide additional illustrative examples, the deformation body 504 may comprise a multi-layer laminate. For instance, the deformation body 504 may consist of a lower steel spring and an upper FR4-spring, with the layers being bonded to one another in any suitable manner (e.g. glued, cemented, bolted, riveted, etc.) or, alternatively, the layers may be stacked loosely in such a way that the layers can glide laterally against each other, with the former providing a stiffer composite than the latter. It is noted that the different CTEs of the layers may lead to bowing, but since this is isotropic (e.g. identical in all lateral directions) it does not affect the sigXY or sigXX−sigYY measurements performed by the force sensor chip 502.

The force sensor chip 502 may have a square shape or any other suitable shape, with the thickness of the force sensor chip 502 being significantly less (e.g. 10%, 1%, .1%, etc.) than the length and width dimensions of the force sensor chip 502. As an illustrative example, a typical size of the force sensor chip 502 may be approximately 1 mm×1 mm×0.1 mm. However, it may be particularly useful for the force sensor chip 502 to have a square shape so as to not favor the stress in one direction over another perpendicular direction, as discussed in further detail below.

In any event, given the two-dimensional nature of the force sensor chip 505, the biaxial state of stress from the deformation body 504 may be efficiently coupled into the force sensor chip 502. This stress may be the result of a force that is applied to the force sensor package 500 in a direction that is normal to the surface of the force sensor chip 502. Moreover, due to the two or more force sensor elements that form part of the force sensor chip 502, the force sensor chip 502 is configured to generate one or more force measurement signals in response to the applied force, which deforms the deformation body 504 and results in one or more measurement signals being measured by way of the change in the electrical parameter of the force sensor elements. The one or more measurement signals are indicative of a measurement of in-plane stress components. In this way, the force sensor chip 502 outputs at least one force measurement signal that is indicative of a measurement of in-plane stress components induced into the deformation body 504.

To clarify the in-plane stress components that are measured via the force sensor chip 502 in this manner, it is useful to provide a reference coordinate system. Thus, and with continued reference to FIG. 5A, the force sensor chip 502 may primarily occupy an x-y plane with respect to this coordinate system such that the in-plane stress components that are measured are defined in accordance with the alignment of the force sensor chip 502 with respect to the x- and y-axis of the x-y plane. For example, for the embodiment as shown in FIG. 5A, the x- and y-axes are parallel to the edges of the force sensor chip 502. To this end, it is also noted that the force sensor elements of the force sensor chip 502 may be disposed perpendicular to one another and parallel to the edges of the force sensor chip 502 (e.g. aligned with the x- and y-axes), although the embodiments are not limited to this arrangement.

Continuing this example, the force sensor package 500 may be mounted for a particular application such that the force applied to the force sensor package 500 is normal to the surface of the force sensor chip 502, for example primarily in the −z direction. Additionally, the deformation body 504 may comprise two lines of symmetry, which are also denoted in FIG. 5A as the ‘1’ and ‘2’ axes. Thus, for the embodiment as shown in FIG. 5A, the x-y axes are rotated 45 degrees from the 1-2 axes associated with the lines of symmetry of the deformation body 504.

With this coordinate system and configuration in mind, the arrangement and coupling between the force sensor chip 502 and the deformation body 504 as shown in FIG. 5A is now considered, e.g. when the x-y axes are rotated 45 degrees from the 1-2 axes associated with the lines of symmetry for the deformation body 504. In this scenario, the force sensor chip 502 may detect, in response to an applied force in the −z direction, in-plane shear stress components of the deformation body 504 (i.e. sigXY). However, if the force sensor chip is rotated such that the x-y-axes are aligned with the 1-2 axes associated with the lines of symmetry for the deformation body 504, then the pure shear stress becomes a biaxial normal stress state with sigXX=−sigYY, and zero shear stress. Hence, measuring sigXY by a shear stress-sensor is the same as measuring sigXX−sigYY in a 45° rotated reference frame. In other words, the force sensor chip 502 may be configured to measure in-plane stress components of the deformation body 504 that are parallel to the chip edge or along the diagonals of the chip based upon the manner in which the force sensor chip (and its accompanying force sensor elements) are aligned with the geometry of the deformation body 504.

In other words, force sensor elements may be placed on the force sensor chip 502 as noted herein, and the one or more measurement signals provided by the force sensor elements facilitate the detection of sigXX and sig YY (or alternatively sigXX−sigYY and sigXX+sigYY). That is, if the deformation body 504 is deflected along the x-direction, it provokes positive sigXX and a small negative sigYY (due to Poisson-contraction) on the force sensor chip 502. However, if the deformation body 504 heats up, it expands in a predominantly uniform manner in x- and the y-directions. Thus, the force sensor chip 502 detects a very small sigXX−sigYY and much larger sigXX+sigYY, from which it may then be deferred that there is no external force acting on the deformation body 504. In this way, a temperature dependent zero-point error of force measurement is avoided via the force sensor package 500 as discussed herein.

It is noted that traditional stain gauges could be used instead of the force sensor elements of the force sensor chip 502 by orienting the strain gauges perpendicularly to each other and using an electronic circuit to compare the resistances of both in response to the applied force. For instance, if one strain-gauge is aligned with the x-direction and the other one with the y-direction, a uniform strain in both directions leads to identical changes in both strain-gauge resistances (Rx/Ry˜constant) and a deflection of the deformation body 504 in the in x-direction increases Rx and slightly decreases Ry (therefore Rx/Ry increases). For example, Rx and Ry may be implemented as metallic resistors disposed on top of the force sensor chip 502 instead of the aforementioned use of the force sensor elements. However, it is noted that metallic resistors change very little with stress (˜1%/GPa in silicon), whereas the mobility in other types of force sensor elements described herein, such as low doped resistors or MOSFETs in a single silicon crystal, for instance, respond to stress with ˜20 . . . 50%/GPa in silicon. Another issue with the use of traditional strain gauges is the precise relative alignment of two strain-gauges and their large size compared with much smaller micro-electronic devices. Thus, the use of the two dimensional force sensor chip 502 and its accompanying force sensor elements as discussed in this Section may be particularly advantageous to address these issues.

### B. The Various Shapes and Implementation of the Integrated Deformation Body

The deformation body 504 is shown in FIG. 5A as a planar spring having a cross shape, although this is by way of example and not limitation, and the embodiments as discussed herein may comprise a deformation body 504 having any suitable shape, as discussed in further detail below. However, it may be particularly useful to implement a deformation body having symmetry or rotational symmetry, as discussed in further detail herein. Referring now to the shape of the deformation body 504 as shown in FIG. 5A, the deformation body 504 may comprise a cross shape with four arms of equal length, and may include the rounded corners or recesses as shown, which are positioned with each one of the arms.

The force sensor package 500 also comprises an upper housing 510.2 that is disposed at a first side of the deformation body 504, and a lower housing 510.1 that is disposed at a second side of the planar spring opposite to the first side. In other words, the upper and lower housings 510.1, 510.2 may be substantially parallel with one another, excepting for manufacturing tolerances. To ensure that force is coupled into the force sensor package 500, the deformation body 504 may have any suitable number of supports 506, 508, and any of these supports 506, 508 may be coupled to one of the upper and lower housing 510.1, 510.2, as shown in FIGS. 5A and 5B for example, which may be a function of the particular shape of the deformation body 504. Thus, any of the supports 506, 508 as discussed herein may be alternatively referred to as a force coupler, which is configured to induce stress into the deformation body 504 by way of the deformation (e.g. bending) of the deformation body 504, as discussed in further detail herein.

For example, the deformation body 504 as shown in FIG. 5A may include first and a second support 506.1, 506.2, and a third and a fourth support 508.1, 508.2. For case of explanation, the supports 506.1, 506.2 may alternatively be referred to herein as an upper support pair, given their adjacency to the upper housing 510.2, whereas the supports 508.1, 508.2 may alternatively be referred to herein as a lower support pair, given their adjacency to the lower housing 510.1. The supports 506.1, 506.2, and 508.1, 508.2 may each be formed as part of the deformation body 504, such as by bending or otherwise forming the respective portions of the deformation body 504 via any suitable manufacturing process. In this scenario, the deformation body 504 and any of the supports 506.1, 506.2, and 508.1, 508.2 may form a single, unitary component. In other embodiments, the supports 506.1, 506.2, and 508.1, 508.2 may comprise separate components that are affixed to their respective portions of the deformation body 504 via any suitable bonding process, such as adhesives, welding, soldering, etc. In still other embodiments, which are discussed in further detail below, one or more of the supports 506.1, 506.2 may be formed as part of the upper housing 510.2. Additionally or alternatively, one or more of the supports 508.1, 508.2 may be formed as part of the lower housing 510.1. Embodiments may also include combinations of these configurations. For instance, one the supports 506.1, 506.2, 508.1, 508.2 may be formed as part of the upper or lower housing 510.1, 510.2, whereas another one of the supports 506.1, 506.2, 508.1, 508.2 may be formed as part of the deformation body 504.

In any event, and as noted above, the deformation body 504 may be symmetric in shape, have 90 degree rotational symmetry, and comprise the two lines of symmetry denoted in FIG. 5A as the ‘1’ and ‘2’ axes. As the supports 506.1, 506.2, and 508.1, 508.2 are implemented to couple an applied force into the deformation body 504, which is discussed in further detail below, the supports 506.1, 506.2, and 508.1, 508.2 may be disposed on the deformation body 504 in accordance with these lines of symmetry. For instance, each of the supports 506.1, 506.2, and 508.1, 508.2 may be disposed at a distal end of each respective one of the four arms of the deformation body 504 as shown in FIG. 5A, for instance.

In this arrangement, each of the supports 506.1, 506.2 is disposed at respective locations of the deformation body 504 that are opposite to one another with respect to the first line of symmetry of the deformation body 504, which may be defined in this example as shown in FIG. 5A by way of the ‘1’ axis. Additionally, each of the supports 508.1, 508.2 is disposed at respective locations of the deformation body 504 that are opposite to one another with respect to a second line of symmetry of the deformation body 504, which may be defined in this example as shown in FIG. 5A by way of the ‘2’ axis. The first and the second lines of symmetry may be orthogonal to one another.

Thus, an applied force, which again may be applied in a direction that is normal to the surface of the force sensor chip 502, may be distributed to the deformation body 504 via each of the supports 506.1, 506.2, and 508.1, 508.2. As discussed in greater detail below, because the force sensor chip 502 is coupled to the deformation body 504, this also results in stresses being generated in the force sensor chip 502, which may be measured via the force sensor elements as discussed herein. In this way, when a force is applied to the force sensor package 500 in a direction that is normal to the surface of the deformation body 504, the arrangement between the force sensor chip 502, the deformation body 504, and each of the supports 506.1, 506.2, and 508.1, 508.2 results in the generation of in-plane normal stresses in two orthogonal directions in the force sensor chip 502, which have different values. Again, because the force sensor chip 502 may be disposed in the center of the deformation body 504, the force sensor chip 502 is located far from the distal ends of the arms of the deformation body 504, at which locations the forces couple into to the deformation body 504. Therefore, the stresses measured by the force sensor package 500 are less influenced by placement errors of the force sensor chip 502 on the deformation body 504.

Again, the force sensor chip 502 may include two (or more) force sensor elements, which may be used to measure the stress induced into the force sensor chip 502 as a result of the applied force, which may then be measured by the force sensor chip 502. To do so, and as noted above, the force sensor chip 502 may comprise two force sensor elements that are disposed perpendicular to one another, each having an electrical parameter that responds differently to orthogonal in-plane stress components induced into the deformation body 504 due to the applied force.

Additionally, to measure the applied force, the force sensor chip 502 may include an electronic circuit that is configured to generate a force measurement signal. This force measurement signal may be generated, for example, from one or more measurement signals based upon the electrical parameter change of each of the sensor elements in response to stress distributed into the deformation body due to the applied force. As discussed in further detail herein, these measurement signals may be indicative of different types of in-plane stress components. For instance, the measurement signals may comprise stress measurement signals that are indicative of either in-plane shear stress (sigXY) or the difference of in-plane normal stress components (sigXX−sigYY). The type of in-plane stress components that may be measured in this manner may be a function of various factors such as the geometric orientation of the force sensor chip 502 with respect to the deformation body 504, the type of force sensor elements, as well as the type of silicon material (or its crystal orientation with respect to the surface of the silicon wafer during the semiconductor manufacturing process) used to implement the force sensor elements, as discussed in further detail below.

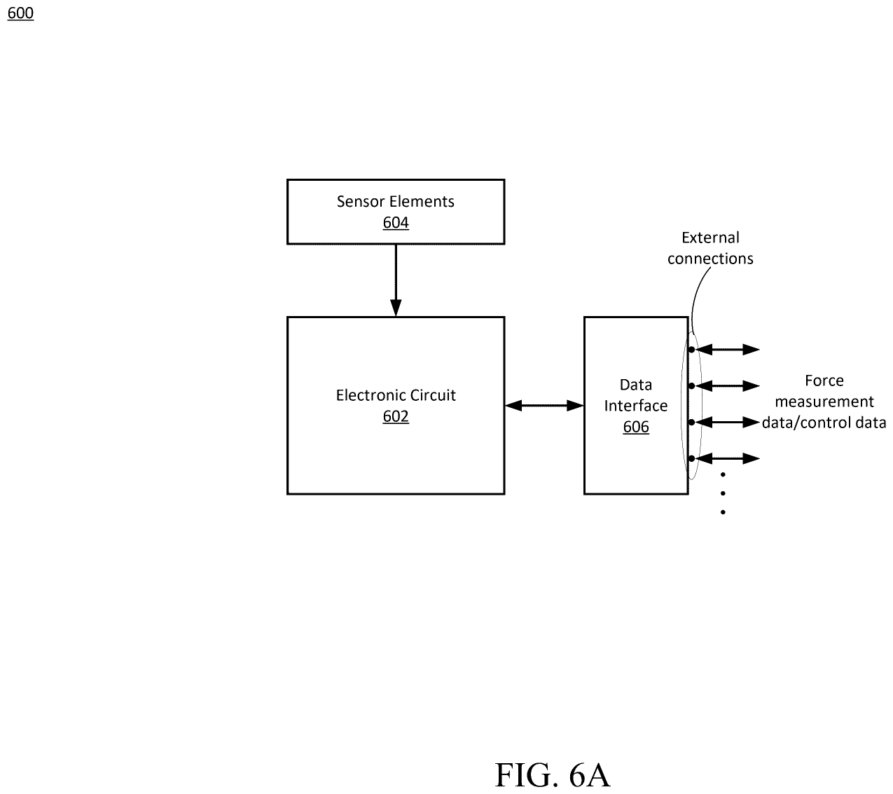

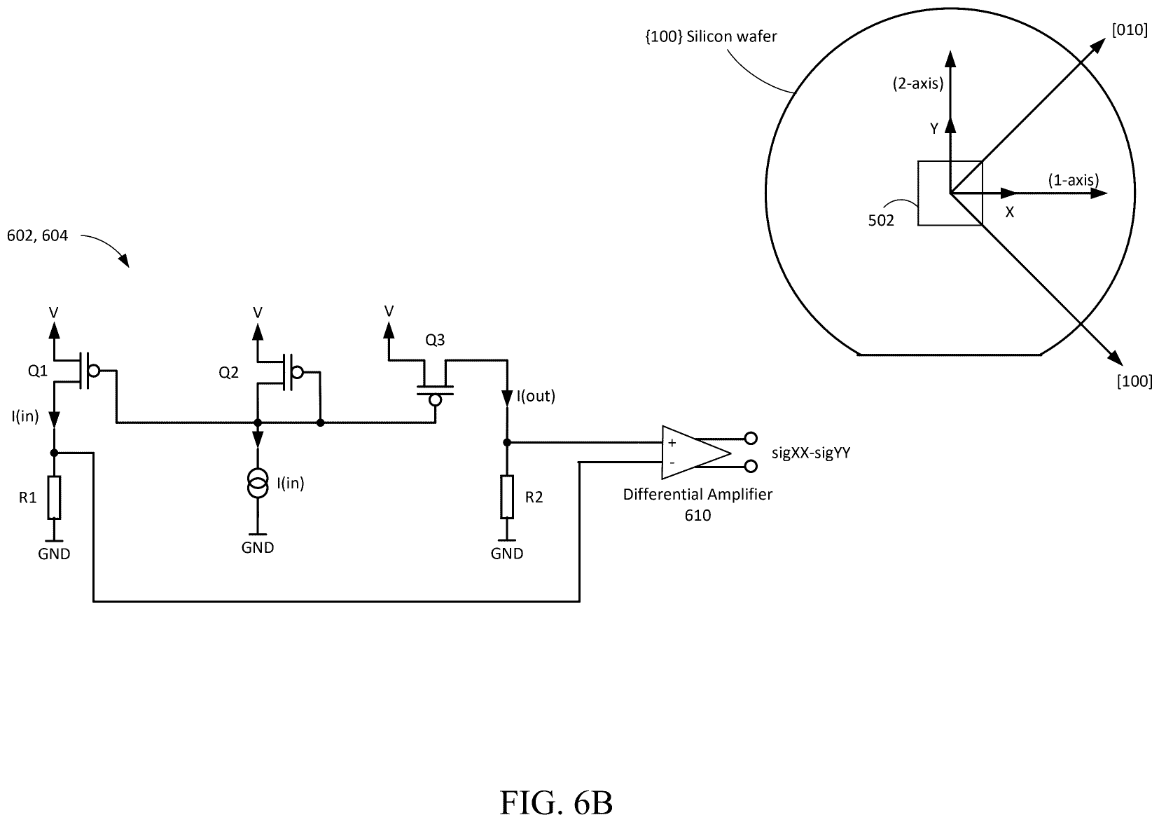

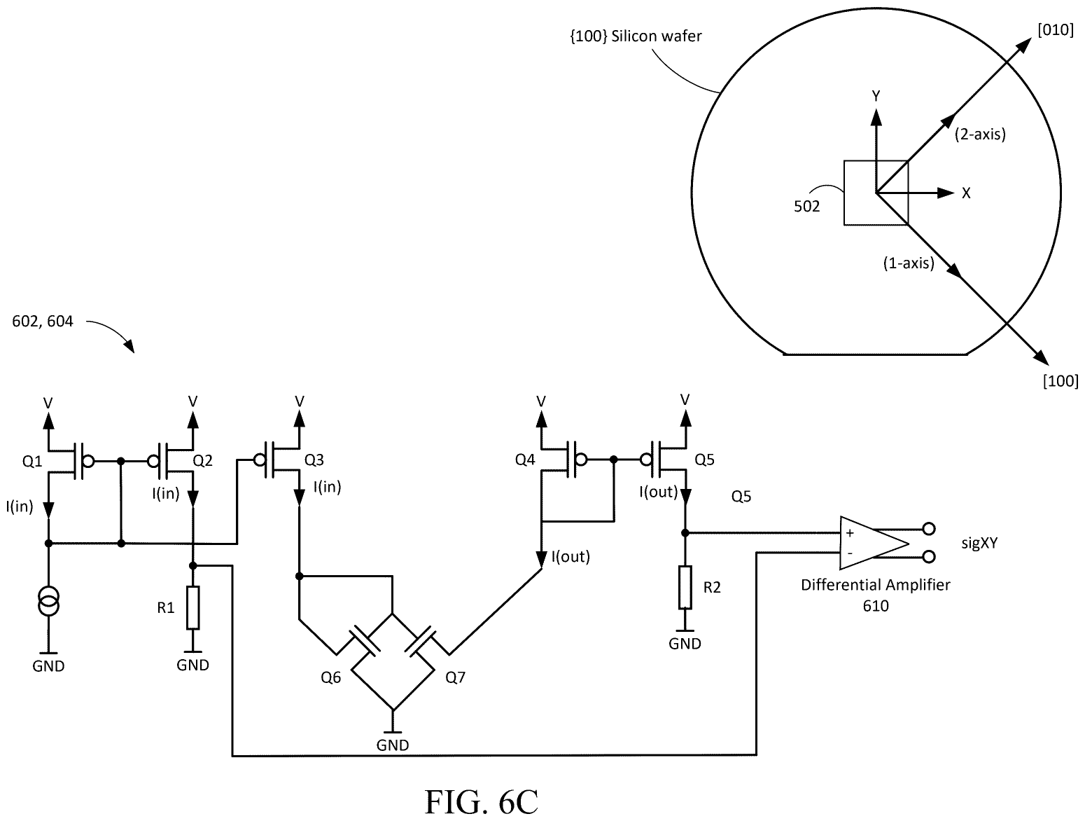

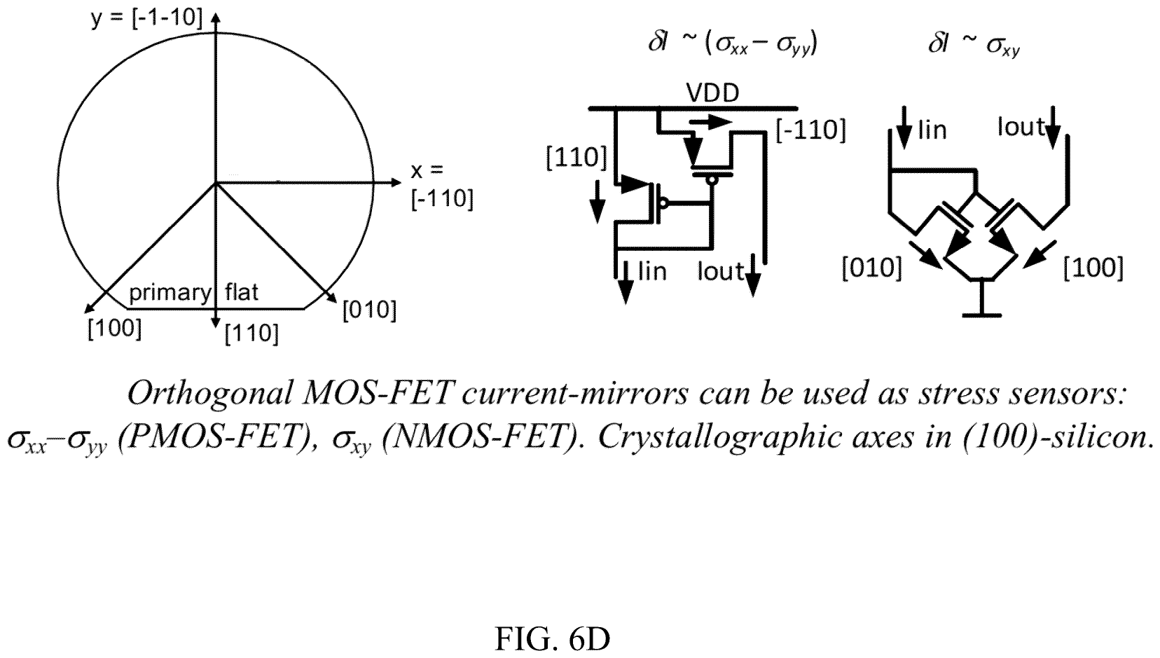

The details of the electronic circuit and the measurement of the applied force are discussed in further detail below with respect to FIGS. 6A-6C. However, as the functionality of the electronic circuit is dependent upon the various factors as noted above, it is prudent to provide a brief discussion with respect to an exemplary configuration of the force sensor 500 that may be implemented to perform such measurements of applied forces. Thus, it is noted that to ensure that an applied force is distributed to the force sensor chip 502, one support of the upper support pair may be mechanically coupled to the upper housing 510.2, and one of the supports in the lower support pair may likewise be mechanically coupled to the lower housing 510.1. Although the mechanical coupling configuration of the upper support pair and the lower upper support pair is not limited to this specific implementation, with additional examples provided further below, this specific implementation is used for case of explanation to describe the operation of the force measurement sensor 500 in further detail.

Thus, and continuing this example, which is used as the primary example to describe the operation of the force sensor 500, one of the supports 506.1, 506.2 may be mechanically coupled to the upper housing 510.2, which may be subjected to the applied force. Additionally, one of the supports 508.1, 508.2 may be mechanically coupled to the lower housing 510.1. Thus, one of the supports 506.1, 506.2, 508.1, 508.2 may be mechanically coupled to the lower housing 510.1 or the upper housing 510.2, as the case may be, using any suitable bonding techniques such as adhesives, soldering, welding, etc.

In accordance with such embodiments, it may be particularly advantageous to couple a single one of the upper and lower support pairs to its respective lower or upper housing 510.1, 510.2, whereas the other support in the upper and lower support pairs remains mechanically decoupled. For instance, only one of the supports 508.1, 508.2 may be mechanically coupled to the lower housing 510.1, while the other one of the supports 508.1, 508.2 may be remain mechanically decoupled (e.g. not bonded or otherwise affixed). Continuing this example, only one of the supports 506.1, 506.2 may be mechanically coupled to the upper housing 510.1, while the other one of the supports 506.1, 506.2 may be remain mechanically decoupled (e.g. not bonded or otherwise affixed). This arrangement allows for one of the supports of each of the upper and lower support pairs to “float” with respect to the lower or upper housing 510.1, 510.2, as the case may be. This ensures that thermal expansion of the deformation body 504 does not result in a twisting of the deformation body 504 due to the captivation of all supports 506.1, 506.2, 508.1, 508.2, which is discussed in further detail below. Additionally, in this arrangement, the force may act on one of the supports in each lower or upper support pair that is not mechanically coupled to its respectively adjacent lower or upper housing 510.1, 510.2.

Turning now to the operation of the electronic circuit included as part of the force sensor chip 502, FIG. 6A illustrates an example block diagram of a force sensor chip including an electronic circuit and external connections, in accordance with an embodiment of the disclosure. The block diagram as shown in FIG. 6A may be identified, for example, with the various components of the force sensor chip 502. Thus, the force sensor chip 502 may include, as shown in FIG. 6A, an electronic circuit 602, at least two force sensor elements 604, which again may be disposed orthogonal to one another, and a data interface 606.

Again, the sensor elements 604 (also referred to herein as force sensor elements) may comprise any suitable type of force sensor elements. Thus, piezo-MOSFETs, which are arranged in a current mirror configuration, are used to describe the operation of the electronic circuit 602 further below by way of example and not limitation. Again, the electronic circuit 602 is configured to generate a force measurement signal from the one or more stress measurement signals, which may be indicative of the in plane stress components resulting from the applied force. The force measurement signal may comprise a conversion of a measured stress indicative of either in-plane shear stress (sigXY) or the difference of in-plane normal stress components (sigXX−sigYY), as noted above, to the corresponding force measurement using any suitable techniques, including known techniques for instance, such as those discussed in Section I above for example. For instance, the force measurement signal may represent a computation using Young's modulus and the known properties of the force sensor chip 502. Alternatively, the force measurement signal may represent either the in-plane shear stress (sigXY) or the difference of in-plane normal stress components (sigXX−sigYY), as noted above, which are then sent to an external device to perform such computations.

In any event, the electronic circuit 602 may provide the force measurement signal to the data interface 606, which is configured to output the force measurement signal to an external device such as a microcontroller, an electronic control unit, etc. The data interface 606 may also enable the force sensor chip 502 to receive data from an external device, which may comprise control and/or configuration data for instance. Thus, the data interface 606 may be implemented as any suitable number and/or type of components to facilitate the force sensor chip 502 transmitting and/or receiving data from an external device as discussed herein. For example, the data interface 606 may comprise any suitable number of ports, pins, drivers, bond pads, wires, buffers, etc. In various embodiments, one or more portions of the data interface 606 may be integrated with the electronic circuit 602. Thus, the data interface 606 may comprise the internal connections within the force sensor chip 502 from and/or within the electronic circuit 602 and/or the external connections (e.g. bond pads) of the force sensor chip 502, or any suitable combination thereof that enables the transfer of data as noted herein.

Examples of the electronic circuit 602 and the force sensor elements 604 are shown in further detail in FIGS. 6B and 6C. Again, the electronic circuit 602 and the sensor elements 604 may form part of the force sensor chip 502, which may be implemented using any suitable type of semiconductor materials, such as silicon for example. For ease of explanation, the operation of the electronic circuit 602 and the sensor elements 604 are described herein with respect to the use of standard {100} orientation silicon (as it is commonly used for CMOS technologies) for the force sensor chip 502, which is with respect to the Miller Index, as shown in the upper right corner of FIGS. 6B and 6C. However, for other embodiments, a different orientation of silicon may be implemented for the force sensor chip 502, which will modify the operation of the force sensor elements in response to the applied force, as further discussed below.

Therefore, and as one example, the force sensor chip 502 may be implemented as any suitable type of semiconductor having any suitable crystallography configuration. For instance, the force sensor chip 502 may comprise cubic semiconductors (e.g. as silicon and germanium), which have three mutually perpendicular axes. Two of these crystallographic axes of the force sensor chip 502 may comprise in-plane axes that are orthogonal to one another, which may be aligned with the first and the second lines of symmetry of the deformation body, as shown in FIG. 6B, in which case a PMOS current mirror configuration may be implemented. The third crystallographic axis of the force sensor chip 502 may comprise the z-axis, for instance, which is mutually perpendicular to the other two in-plane axes as noted above. As another example, the crystallographic axes of the force sensor chip 502 may be rotated by 45 degrees from the first and the second lines of symmetry of the deformation body 504 (e.g. rotated about the z-axis or the third crystallographic axis as noted above, which may represent the same axis), as shown in FIG. 6C, in which case an NMOS current mirror configuration may be implemented.

In addition to the use of a specific orientation of silicon, the orientation of the force sensor chip 502 with respect to the deformation body 504 also influences the operation of the force sensor chip 502, with the resulting stress measurement signals representing different types of orthogonal in-plane stress components in each respective case as noted above. For example, the force sensor chip 502 may comprise a first and a second crystallographic axis, which are denoted as the x and y-axes as shown in FIGS. 6B and 6C. The force sensor elements 604 may be disposed on the silicon of the force sensor to chip aligned with these crystallographic axes such that the force sensor elements are aligned with (e.g. parallel with) the edges of the force sensor chip 502 with respect to the direction of sensitivity to induced stress. In other words, the force sensor elements 604 may be orthogonal to one another, as discussed in further detail herein. For example, one force sensor element may be disposed on the force sensor chip 502 oriented with the x axis such that its electrical parameter changes in response stresses in the x-axis, whereas the other force sensor element may be disposed on the force sensor chip 502 oriented with the y-axis such that its electrical parameter changes in response stresses in the y-axis. In this context, “oriented” means the direction of main current flow, where “main” means the portion of the current flow that generates a main voltage drop in a resistance. For instance, in a MOSFET, this would be equivalent to the current flow direction in the channel.

The operation of the sensor elements 604 and the electronic circuit 602 are described with respect to the orientation as shown in the FIGS. 6B and 6C, assuming a standard {100} silicon in each case. It is noted that in both cases it is {100}-silicon, because {100} specifies the wafer plane, which is orthogonal to a <100> crystal axis. However, the operation of the force sensor chip 502 may be modified to reverse these use cases when a rotated {100} silicon is implemented for the force sensor chip 502. For example, using rotated {010} silicon, the circuit arrangement as shown in FIG. 6B may be used in accordance with orientation of the force sensor chip 502 with respect to the first and the second lines of symmetry of the deformation body as shown in FIG. 6C, and vice-versa.

The difference between the use cases of FIGS. 6B and 6C, therefore, is that the chip edges in ordinary {100}-silicon are aligned as shown in FIG. 6C, whereas in rotated {100}-silicon the chip edges are aligned as shown in FIG. 6B. In other words, the silicon implemented for the force sensor chip 502 may have a set of crystallographic axes in any suitable direction that is specified with respect to the crystal (e.g. with respect to the [100]-direction). Thus, embodiments as discussed herein may utilize the force sensor chip 502 having specific axes. These axes may, for example, include those from among a set of <100> axes (using the Miller index notation) that are either aligned or rotated (e.g. by 45 degrees) with respect to the 1- and 2-axes of the deformation body 504 as shown and discussed herein with respect to FIGS. 6B and 6C for example.

As shown in FIG. 6B, the sensor elements comprise the PMOS transistors Q2, Q3, which are oriented orthogonal to one another in the physical layout (this is indicated by rotating the symbols of the transistors in the schematic view of FIG. 6B) and may be aligned with the x- and y-axes of the force sensor chip 502 as discussed above, such that the currents through the MOSFET channels flow along <110> directions of the silicon single crystal. The PMOS transistors Q2, Q3 may comprise, for example, piezo-MOSFETs, and thus the electrical parameter that responds to the in plane stress components induced into the deformation body 504 may comprise a current gain of the PMOS transistors Q2, Q3. In such an arrangement, the electronic circuit 602 may comprise an input transistor Q2, which is coupled to a current source and arranged in a current mirror configuration with the sensor element transistor Q3. Thus, a current signal provided by the current source is input to the transistor Q2, which is electrically coupled to the transistors Q1, Q3 such that the transistors Q1, Q3 output a respective current signal as shown. It is noted that in the configuration as shown in FIG. 6B, the PMOS transistors Q2-Q3 form one current mirror, and the PMOS transistors Q2-Q1 form another current mirror. However, Q1 and Q2 have an identical orientation, and therefore the current mirror ratio for the PMOS transistors Q2-Q1 does not depend on mechanical stress. However, because the PMOS current mirror formed by the PMOS transistors Q2-Q3 have an orthogonal orientation with respect to one another, this current mirror ratio does depend on mechanical stress.

In this configuration, the input current I(in) provided by the current source is output by the drain terminal of the force sensor element transistor Q1, and a resulting output current I(out) is output by the drain terminal of the force sensor element transistor Q3. In this configuration, it is noted that each of the transistors Q1, Q3 responds to stress in the x- and y-directions. Thus, if one of the transistors Q1, Q3 increases its drain current at a growing sigXX, it decreases its drain current at a growing sigYY. Thus, if the other transistor Q1, Q3 is rotated by 90° such that the drain currents through the transistors Q1, Q3 are orthogonal to one other, by symmetry the rotated transistor now functions in the opposite manner, i.e. by decreasing its drain current at an increasing sigXX and increasing its drain current at a growing sigYY.

Thus, the I(in) and I(out) currents may represent respective stress measurement signals, as discussed herein. And due to the alignment of the x- and y-axes of the force sensor chip and the 1- and 2-axes of the deformation body 504, an induced force does not generate in-plane shear stress (sigXY), but instead results in the generation of in-plane normal stress components sigXX and sigYY. Thus, the I(in) and I(out) currents output by the PMOS transistors Q1, Q3 may represent these in-plane normal stress components sigXX and sigYY. In other words, each of the PMOS transistors Q1, Q3 responds to sigXX and sigYY simultaneously. That is, at a constant gate-source voltage, the drain current increases with sigXX and decreases with sigYY, or the drain current decreases with sigXX and increases with sigYY (depending on its alignment in the x- or the y-axis).

The electronic circuit 602 may also comprise a differential amplifier 610, and the current signals output by the PMOS transistors Q1, Q3 may be coupled to the inputs of the differential amplifier 610 as shown in FIG. 6B. As a result, the differential amplifier 610 outputs, as the force measurement signal in this example, the difference between the in-plane normal stress components sigXX and sigYY in response to a force that is applied normal to the surface of the force sensor chip 502.

Thus, the force sensor package 500 is configured to respond to a vertically-applied force with horizontally-induced stress measurements. This is due to the shape and orientation of the deformation body 504 as well as the manner in which the various portions of the deformation body 504 are mechanically coupled and decoupled from the force sensor package components, as discussed in further detail herein. For instance, by coupling a force into the deformation body via the extremities (e.g. the distal arms), a vertically-applied force bends the deformation body 504 and the force sensor chip 502. This bending action enables only lateral stress sigXX, sigYY to be induced into the force sensor chip 502, as discussed herein.

Turning now to FIG. 6C, the sensor elements comprise the NMOS transistors Q6, Q7, which are oriented orthogonal to one another in the physical layout (this is indicated by rotating the symbols of the transistors in the schematic view of FIG. 6C) and may be aligned with the x- and y-axes of the force sensor chip 502 as discussed above such that the currents through the MOSFET channels flow along <100> axes. And, as noted above, the NMOS transistors Q6, Q7 may comprise, for example, piezo-MOSFETs, and thus the electrical parameter that responds to the in plane stress components induced into the deformation body 504 may comprise a current gain of the NMOS transistors Q6, Q7. In such an arrangement, the electronic circuit 602 may comprise input transistors Q1, Q2, Q3 and output transistors Q4, Q5. The input transistors Q1, Q2, Q3 may form a first current mirror, with the drain terminal of the Q1 and Q3 transistors being coupled to the current source as shown. Additionally, the output transistors Q4, Q5 may form a second current mirror, with the drain terminal of the transistor Q4 providing an output current I(out) as shown. The current mirror ratios of Q1-Q2, Q1-Q3, and Q4-Q5 may be independent of mechanical stress, because the direction of the drain currents of their input and output transistors are parallel to one another.

In this configuration, the input current I(in) provided by the current source is coupled to the NMOS transistor Q6, and the output current I(out) is coupled to the NMOS transistor Q7. Thus, the I(in) and I(out) current may represent respective stress measurement signals, as discussed herein, which are also identified with their respectively induced voltage signals provided to the differential amplifier 610 as shown in FIG. 6C. And due to the alignment of the x- and y-axes of the force sensor chip 502 and the 1- and 2-axes in this example, an applied force generates in-plane shear stress (sigXY) but not in-plane normal stress components sigXX and sigYY. Thus, the stress measurement signals may represent the in-plane shear stress components sigXY, with sigXY being measured by the pair of orthogonally oriented NMOS transistors Q6, Q7. The electronic circuit 602 may also comprise a differential amplifier 610, and the stress measurement signals may be coupled to the inputs of the differential amplifier 610 as shown in FIG. 6C. As a result, the differential amplifier 610 outputs, as the force measurement signal in this example, the in-plane shear stress sigXY in response to a force that is applied normal to the deformation body 504 and is coupled to the surface of the force sensor chip 502.

FIG. 6D also illustrates additional detail with respect to the orientation of the stress sensor elements as shown in FIGS. 6B and 6C. For example, FIG. 6D illustrates additional detail regarding the alignment of the stress sensor elements for a standard crystallography axis of the force sensor chip 502. Although the operation of the circuits as shown in FIGS. 6B and 6C have been described in terms of MOSFET stress sensor elements, the stress sensor elements implemented via the force sensor chip 502 are not limited to these examples. For example, the force sensor chip 502 may alternatively or additionally implement resistors as the stress sensor elements or part of the stress sensor elements (e.g. in combination with the MOSFETs as discussed above). Such resistors may be formed in the same silicon on which the force sensor chip 502 is manufactured, which may include the use of any suitable techniques to do so, including known techniques. For example, the stress sensor elements implemented as resistors may be formed in the silicon of the force sensor chip 502 via such diffusing, implanting, sputtered on top of the silicon such as poly-silicon resistors, etc.

In any event, such resistors may also have a resistance that is dependent on mechanical stress, and thus these resistors may be formed on the force sensor chip 502 in addition to or instead of the MOSFETS described herein to measure mechanical stress. The use of resistors as stress sensor elements is generally known, and such configurations may be combined with the other components of the force sensor package 500 as discussed herein to provide the force measurement data. To provide an illustrative example, the resistors R1 and R2 may be implemented as mechanical stress dependent resistive stress sensor elements, and may be physically rotated 90° with respect to one another (e.g. aligned with the flow of currents through MOSFET channels of the respective Q2 and Q3 MOSFET stress sensor elements). This configuration enables an amplification of the stress dependent signal of the MOSFETs Q2, Q3. Likewise, the configuration as shown in FIG. 6C may be modified to replace the resistors R1 and R2 with mechanical stress dependent resistive stress sensor elements. The resistors R1, R2 as shown in FIG. 6C may also be physically rotated 90° with respect to one another (e.g. aligned with the flow of currents through MOSFET channels of the respective Q6 and Q7 MOSFET stress sensor elements).

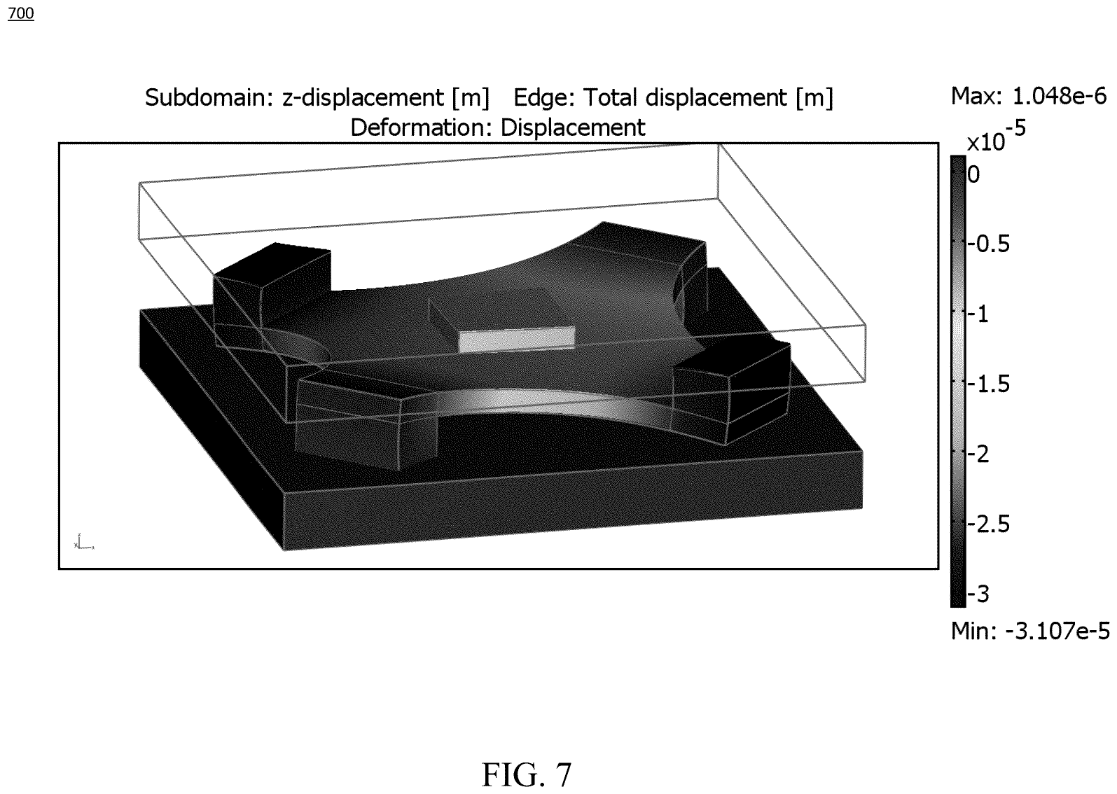

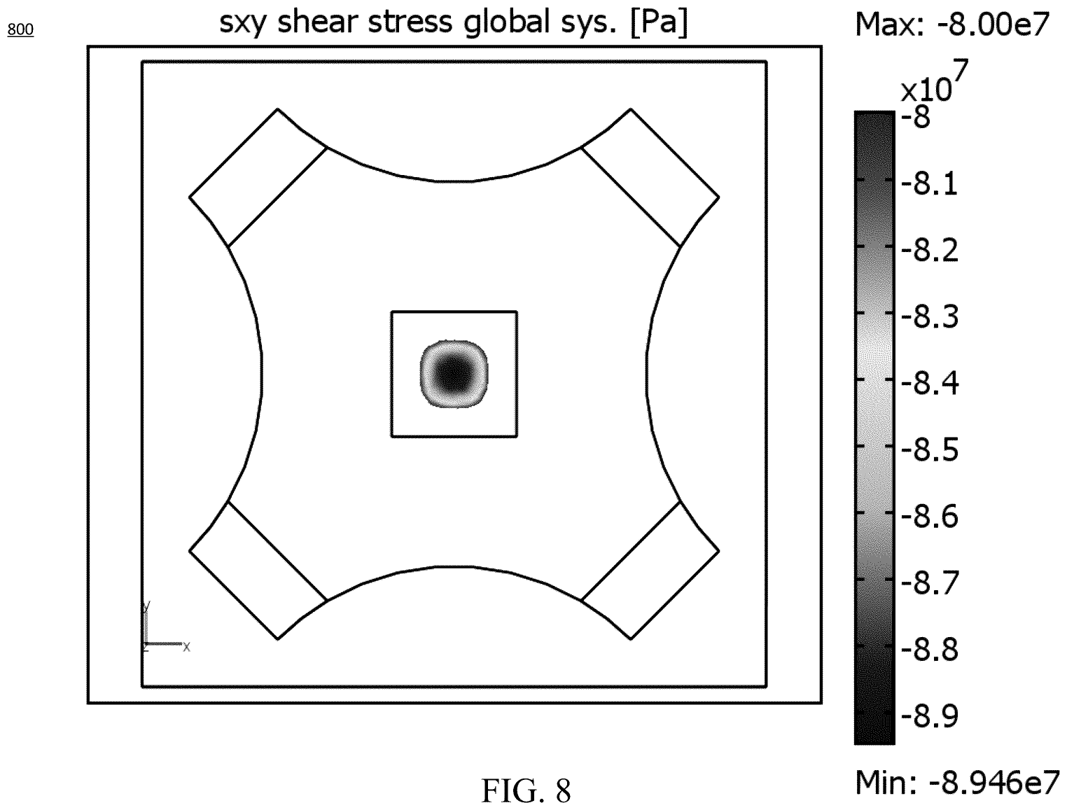

To further explain the operation of the force sensor package 500, reference is now made to FIGS. 7 and 8. FIG. 7 illustrates a resulting deformation of the deformation body 504 in response to a force applied in the −z direction, i.e. normal to the surface of the force sensor chip 502 as discussed above. For instance, the applied force results from a compression of the upper housing 510.2, as shown in FIG. 5B, in a direction towards the force sensor chip 502. For the example shown in FIG. 7, it is assumed that the upper housing 510.2 is displaced by −30 μm in the −z direction by the external force. In response, the two supports 508.1, 508.2 are pulled upwards, and the two supports 506.1, 506.2 are pushed downwards. Thus, along the direction of the 2-axis, the force sensor chip 502 surface is compressed, whereas the force sensor chip 502 surface is under tension in the orthogonal direction (i.e. the 1-axis). This corresponds to a difference of in-plane normal stress components in these two directions: sig11-sig22. Thus, if the force sensor chip 502 is placed as shown in FIG. 7, then the force sensor chip 502 surface has a large shear stress sigXY, which may be for example on the order of −90 MPa (assuming that x and y are parallel to the chip edges).

FIG. 8 illustrates the result of a finite element (FEM) numerical simulation, which shows that the shear stress sigXY (or the difference in normal stresses sigXX−sigYY if the chip is rotated by) 45° is very stable. This remains the case even if the applied force is not perfectly balanced between the two supports 506.1, 506.2, or when the force is not exactly normal to the surface of the force sensor chip 502.

### C. Captivation of the Deformation Body

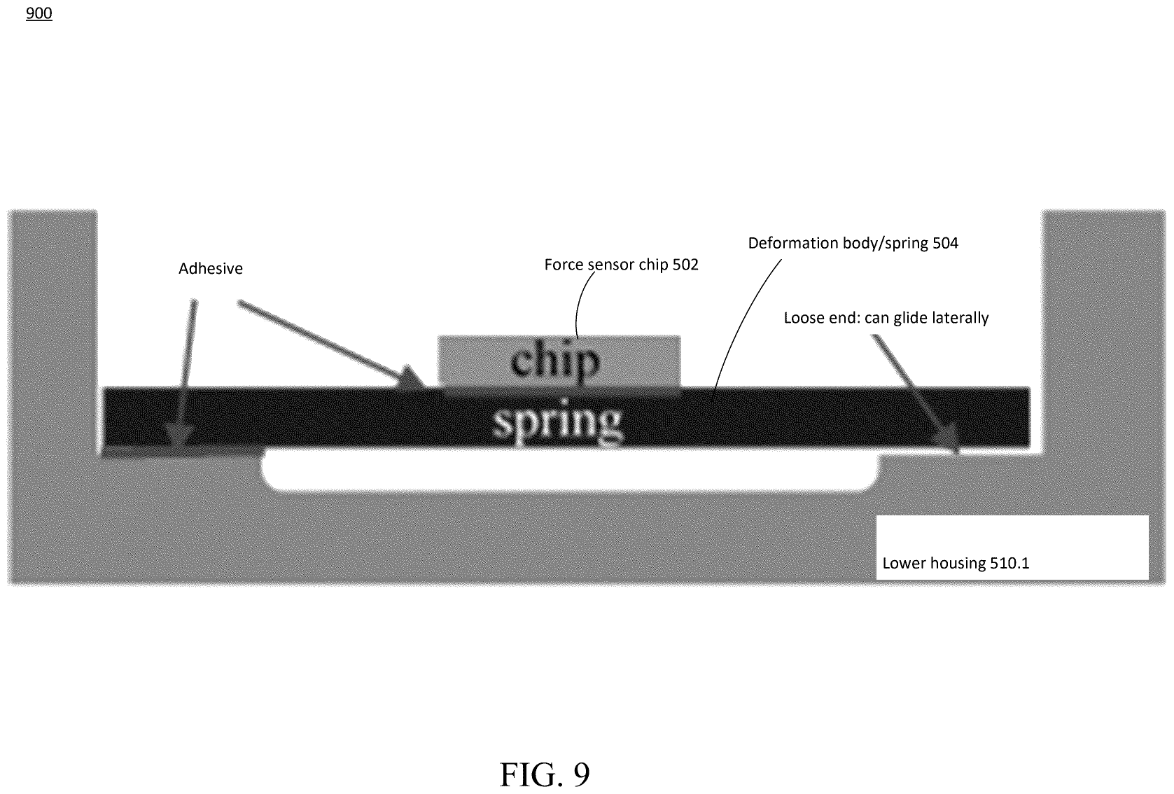

Again, it may be particularly advantageous to mechanically couple a single one of the support pairs 506.1, 506.2, 508.1, 508.2 to its respective upper or lower housing 510.2, 510.1, whereas the other support in the support pair remains mechanically decoupled. To this end, it is noted that conventional springs used for strain gauges are strips as opposed to two-dimensional, and thus it is a straightforward process to captivate the spring at one side, which is illustrated in FIG. 9 as the left side, when a force is applied to the right side. Thus, by mechanically coupling one of the support pairs 506.1, 506.2, 508.1, 508.2 to its respective upper or housing lower 510.2, 510.1, a similar effect may be achieved. It is noted that although one of the support pairs 506.1, 506.2, 508.1, 508.2 may be mechanically coupled to its respective upper or housing lower 510.2, 510.1, there should be no gap (or a minimal gap, excepting for manufacturing tolerances) between the deformation body 504 and the lower housing 510.1 and the upper housing 510.2.

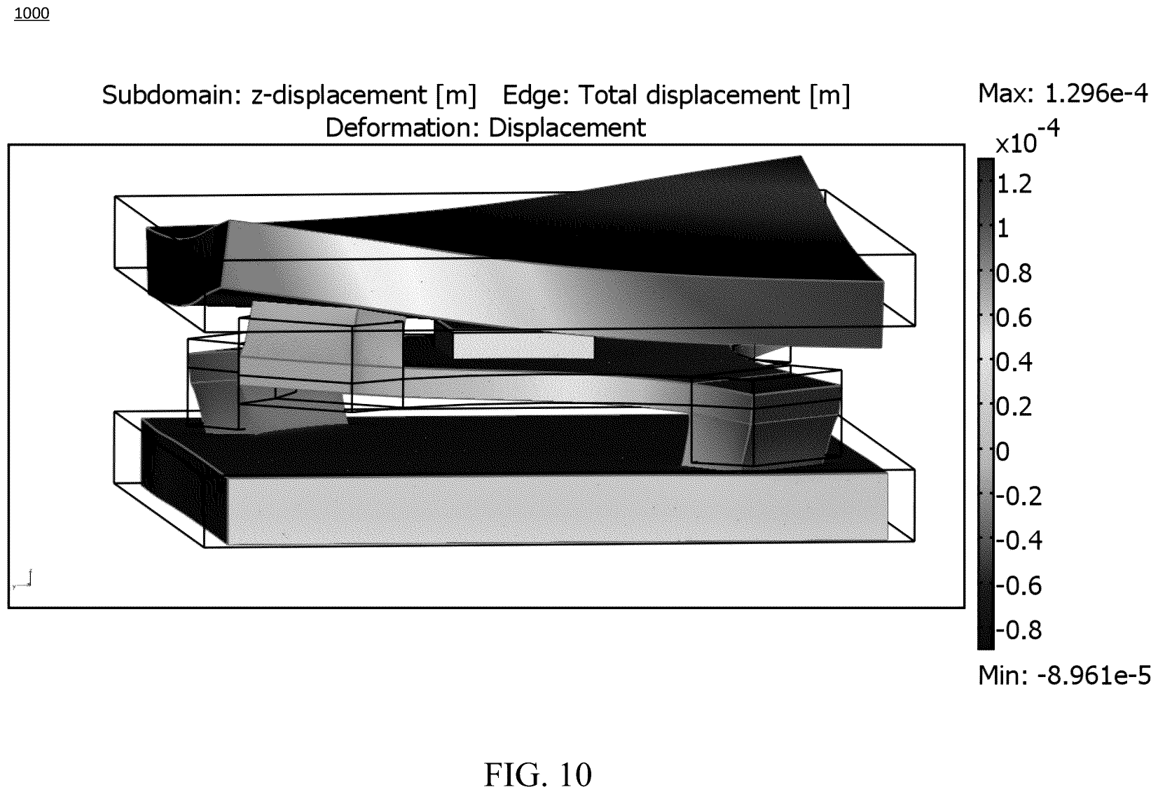

In contrast, clamping each one of the support pairs 506.1, 506.2, 508.1, 508.2 to its respective upper or lower housing 510.2, 510.1 would yield a temperature dependent zero-point error. For instance, the lower housing 510.1 may be formed of a polymer, which shrinks at colder temperatures compared to the deformation body 504. This would result in a bowing of the deformation body 504, which cannot be distinguished by the electronic circuit 602 from a deflection of the deformation body 504 due to an applied force. This issue is shown in greater detail in FIG. 10, which illustrates a deformation plot of the force sensor package 500 in such a scenario. For the plot shown in FIG. 10, it is assumed that each of the lower and upper housing 510.1, 510.2 is made of a polymer with a much larger CTE than the deformation body 504. Each one of the support pairs 506.1, 506.2, 508.1, 508.2 is glued to its respective upper or lower housing 510.2, 510.1 at a hotter temperature. The plot in FIG. 10 shows the deformation due to the thermal contraction of the polymer lower and upper housing 510.1, 510.2 at room temperature. Thus, the lower housing 510.1 and the upper housing 510.2 shrink excessively, yet the lower housing 510.1 shrinkage causes a tensile stress on the surface of the force sensor chip 502 along the 1-axis direction, while the upper housing 510.2 shrinkage causes a compressive stress on the force sensor chip 502 along the 2-axis.

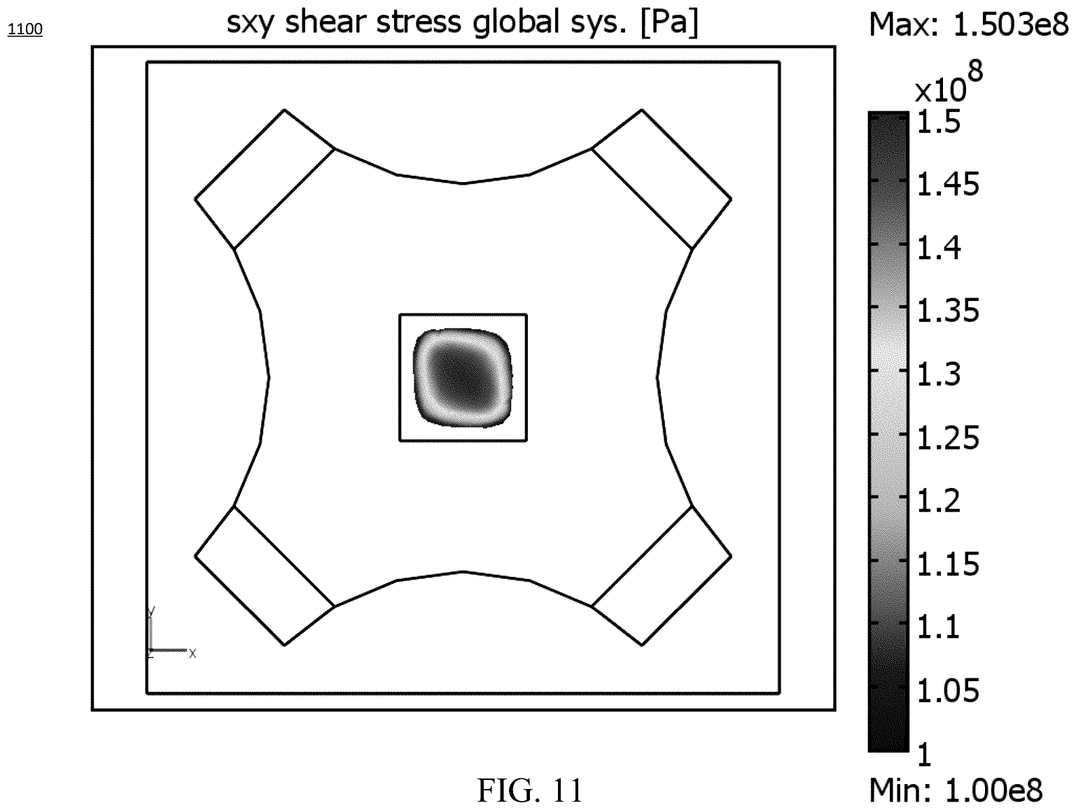

In fact, the shear stress on the surface of the force sensor chip 502 caused by this thermal contraction looks similar to the shear stress caused by an applied external force, which is shown in FIG. 11 as a thermally induced shear stress pattern (compare with FIG. 8). In other words, the thermal shrinkage causes shear stress sigXY on the surface of the force sensor chip 502, and the force sensor chip 502 is unable to distinguish this thermally-induced stress from a stress caused by an externally applied force pushing the upper housing 510.2 downwards. Therefore, to avoid this thermal shrinkage issue, only one a single one of the support pairs 506.1, 506.2, 508.1, 508.2 is clamped (e.g. mechanically coupled) to its respective upper or lower housing 510.2, 510.1, as discussed above, while the other one of the support pairs 506.1, 506.2, 508.1, 508.2 is free to glide laterally to prevent this thermally-induced stress. Moreover, and as noted above, both of the support pairs 506.1, 506.2 may be mechanically decoupled from the upper housing 510.2, as the upper housing 510.2 is in any event pushed towards the deformation body 504 in response to an applied external force. Thus, in accordance with such embodiments, the upper housing 510.2 may be mechanically decoupled from the deformation body 504. Such embodiments may be implemented, for example, by forming the supports 506.1, 506.2 as part of the upper housing 510.2 such that the upper housing 510.2 and the supports 506.1, 506.2 form a unitary component, as noted above for example.

### D. Wire-Bonding of the Force Sensor Chip

The force sensor chip 502 may include any suitable electrical connections to one or more external devices, which may receive the force measurement signals provided by the force sensor chip 502 for instance as discussed above. Thus, the sensor elements 604 and/or the electronic circuit 602 may do so via any suitable number of wires, which may be coupled to the external connections as shown in FIG. 6A for instance, which may be coupled to or form part of the data interface 606. However, such connections introduce significant issues, as the force sensor chip 502 is mounted on the deformation body 504. Thus, due to this mounting configuration, the force sensor chip 502 also moves slightly in response to externally applied forces, and therefore the electric connections between the force sensor chip 502 and any external devices need to be flexible enough to accommodate these movements, and do so in a robust and reliable manner.

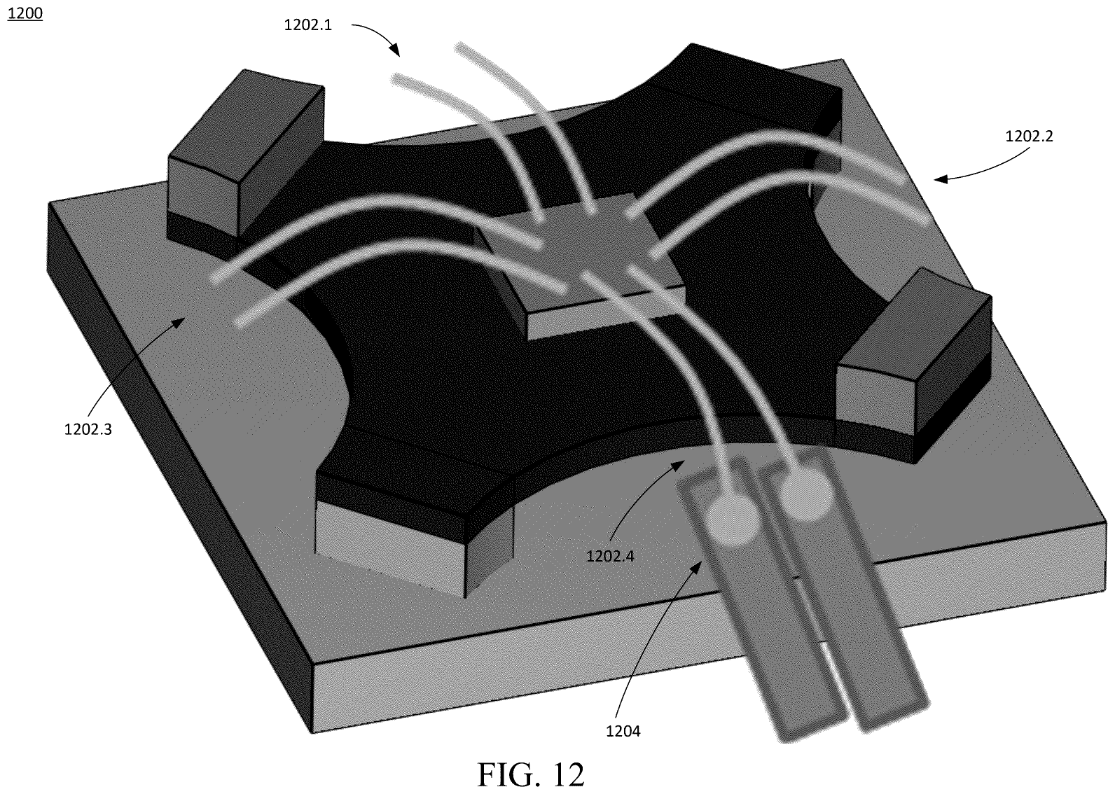

Therefore, and as shown in FIG. 12, in an embodiment long flexible bond wires 1202 may be used to achieve this purpose. It is noted that the number of bond wires as shown in FIG. 12 is provided by any of example and not limitation, and the force sensor package 500 may implement any suitable number and/or type of bond wires. The bond wires 1202 may be bonded to corresponding regions of the force sensor chip 502 using any suitable techniques. For example, the external connections of the force sensor chip 502 may comprise bond pads, bond balls, conductive traces, etc., which are then coupled to the bond wires 1202 using any suitable techniques, including known techniques. It is noted that the bond wires 1202 may have a suitable length so as to not impair the reliability of the wire bond process. Thus, the cross shape of the deformation body 504 may advantageously achieve this result, as the bond wires 1202 may be routed between the arms of the deformation body 504 (e.g. in the recesses) as shown in FIG. 12. In other words, one or more of the bond wires 1202 may be coupled to the force sensor chip 502 and routed between at least one pair of adjacent arms of the four arms of the deformation body 504.

### E. Encapsulation of the Force Sensor Chip

The force sensor package 500 may be encapsulated in various ways. In an embodiment, the force sensor package 502 may be an open cavity type. For example, the force sensor chip 502 and the deformation body 504 may be inserted into the force sensor package 500 from an opening in the top of the force sensor package 500 prior to assembling the upper housing 510.2. For example, the force sensor chip 502 may be bonded to the deformation body 504 to form an assembly, which may then be inserted towards the lower housing 510.2. The deformation body 504 may then be mechanically coupled to the lower housing 510.2, such as by bonding one of the support pairs 508.1, 508.2 to the lower housing 510.1 as discussed herein. Alternatively, the force sensor chip 502 may be bonded to the deformation body 504 after the deformation body 504 is mechanically coupled to the lower housing 510.1.

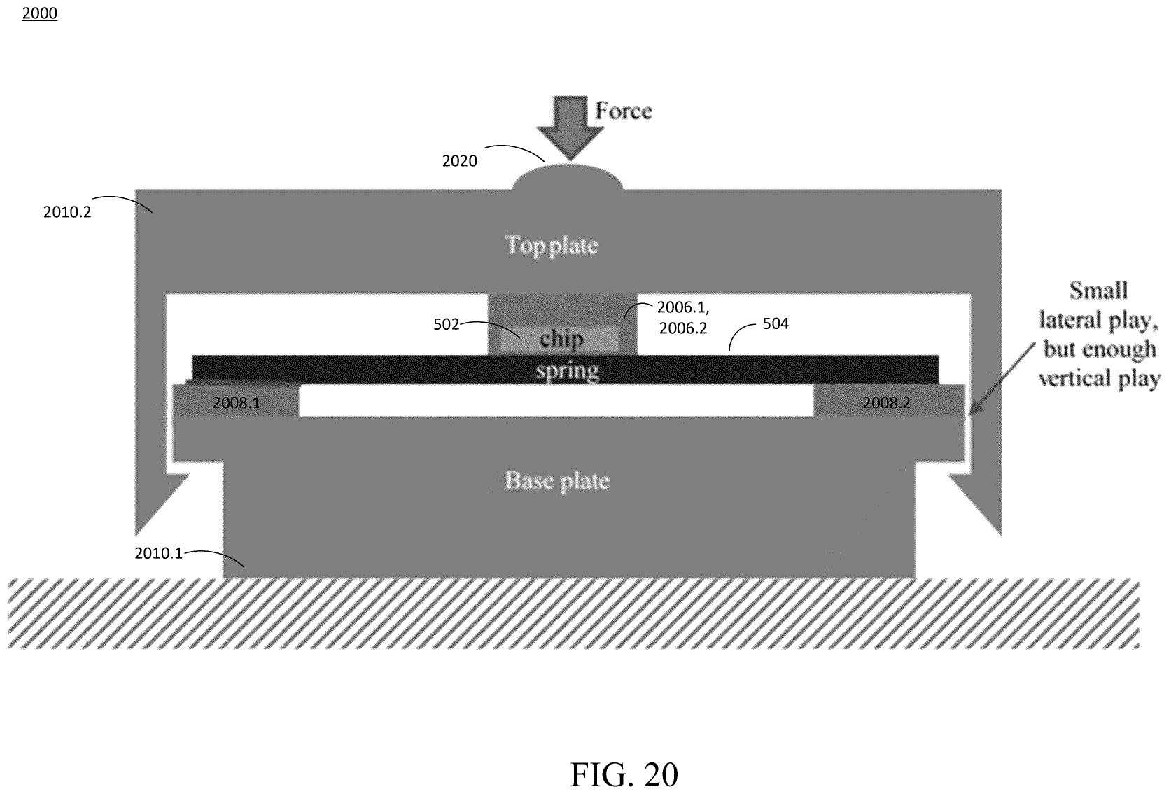

In any event, the bond wires 1202 may then be formed between the force sensor chip 502 and the leads 1204 of the package, as shown in FIG. 12. The force sensor chip 502 and the deformation body 504, as well as the lower and the upper housing 510.1, 510.2 may thus form as assembly, which may include optionally bonding one of the support pairs 506.1, 506.2 to the upper housing 510.2 as discussed herein. An example of such an alternate force sensor package 500 is shown in FIG. 20, which illustrates a force sensor package 2000. The force sensor package 2000 may comprise the same components as the force sensor package 500 as discussed herein, with differences between these force sensor packages further described herein. For example, and as shown in FIG. 20, the force sensor package 2000 comprises a top plate 2010.2 that functions as the upper housing 510.2 as discussed herein with respect to the force sensor 500. Additionally, the force sensor package 2000 comprises a base plate 2010.1, which may function as the lower housing 510.2 as discussed herein. In any event, the top plate 2010.2 may function to close the opening of the force sensor package 2000 to thereby provide the assembled force sensor package. The top plate 2010.2 may have, for example, an outward protrusion (e.g. a rivet or a boss) 2020, at which an applied force can be focused to a well-defined point. The force sensor package 2000 may also include two supports 2006.1, 2006.2, which may function as the supports 506.1, 506.2, and two column parts 2008.1, 2008.2, which may function as the supports 508.1, 508.2 and function to apply the force to the deformation body 504. The top plate 2010.2 may not be rigidly attached to the other components of the force sensor package 2000, because the top plate 2010.2 may then transmit the applied force without losses. The top plate 2010.2 may have a snap on mechanism as shown, which prevents the top plate 2010.2 from detaching from the force sensor package 2000.

### F. Additional Embodiments and Variations

The embodiments are described herein with respect to the use of deformation body 504 having the shape as shown in FIGS. 5A and 5B, which may be implemented to provide a single force sensor package 500. However, and as discussed in further detail below, the deformation body 504 and accompanying supports 506, 508 may vary in their shape and configuration. Additionally, the force sensor package 500 may comprise additional deformation bodies 504 and force sensor chips 502.

For example, and using the deformation body 504 as shown in FIGS. 5A and 5B as an example, the force sensor package 500 may include any suitable number of deformation bodies 504, each comprising a mounted force sensor chip 502 as discussed above. As an illustrative example, a force sensor package 500 may comprise two deformation bodies 504, each having a respective force sensor chip 502 mounted thereon. The two deformation bodies 504 may be configured to react in the opposite manner with respect to in plane stress components that are generated in response to thermally-induced stresses. For instance, the force sensor chip of one deformation body may provide force measurement signals that indicate an increase of applied force with increasing temperature, whereas a force sensor chip of the other deformation body may provide force measurement signals that indicate a decrease of applied force with increasing temperature. Thus, an external device may receive these force sensor measurement signals and average them to determine the applied force. In this way, such a configuration may facilitate a compensation of errors caused by thermally-induced stress. Additionally or alternatively, multiple force sensor packages may be implemented as part of a multi-sensor system to provide two different force measurement signal outputs to provide redundancy. The output of these force measurement signals from each force sensor chip may then be used to verify the applied force measurement by way of confirming matching measurements within a threshold tolerance, used to provide an auxiliary measurement for safety critical applications, etc.

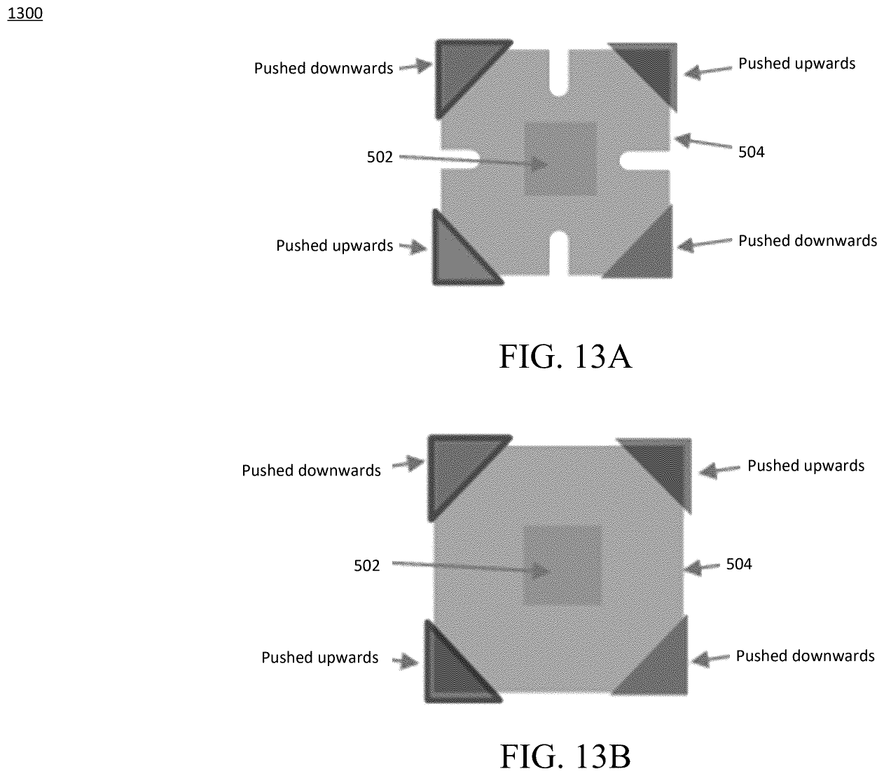

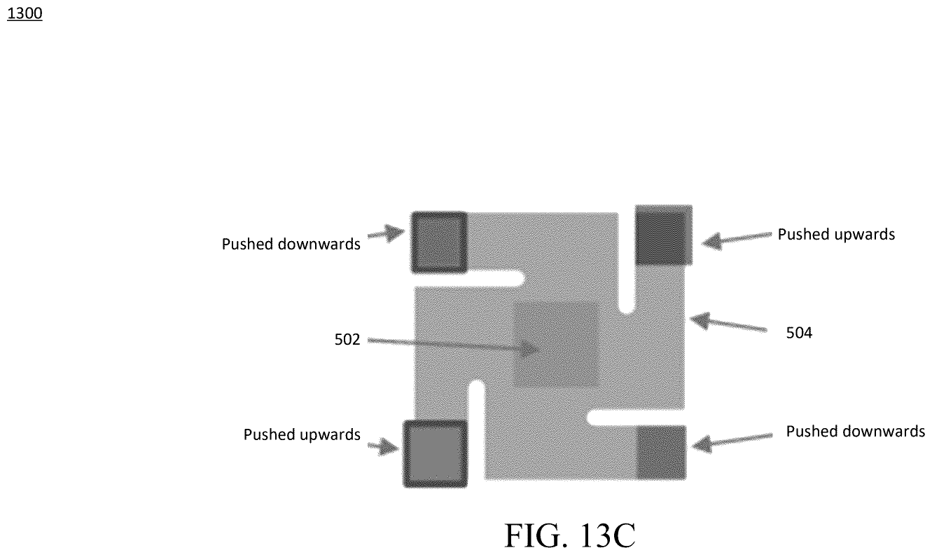

Again, the deformation body 504 may have a variety of different shapes other than the cross shape as in FIGS. 5A-5B. For instance, FIGS. 13A-13C show alternate shapes for the deformation body 504. For each of the alternative deformation body shapes as shown in FIGS. 13A-13C, the deformation body 504 is pushed downwards at the corners as shown as a result of the applied force causing the interaction between the deformation body 504 and the supports 506.1, 506.2 and the upper housing 510.2. Additionally, the deformation body is pushed upwards at the corners as shown as a result of the applied force causing the interaction between the deformation body 504 and the supports 508.1, 508.2 and the lower housing 510.1.

FIG. 13A illustrates the deformation body 504, which may have the shape of a square. The deformation body 504 as shy own in FIG. 13A comprises four slots that extend from the center of each edge towards the force sensor chip 502 as shown. Alternatively, the four slots may extend from other portions of the perimeter of the square, such as from the corners for example (not shown). FIG. 13B illustrates the deformation body 504 as a square without slots. In such an implementation, the deformation body 504 has an increased stiffness. FIG. 13C illustrates a spiral with four arms parallel to the four edges of the perimeter. For the deformation bodies as shown in FIGS. 13A and 13C, the notches may also be used to route bond wires, as discussed above with respect to FIG. 12.

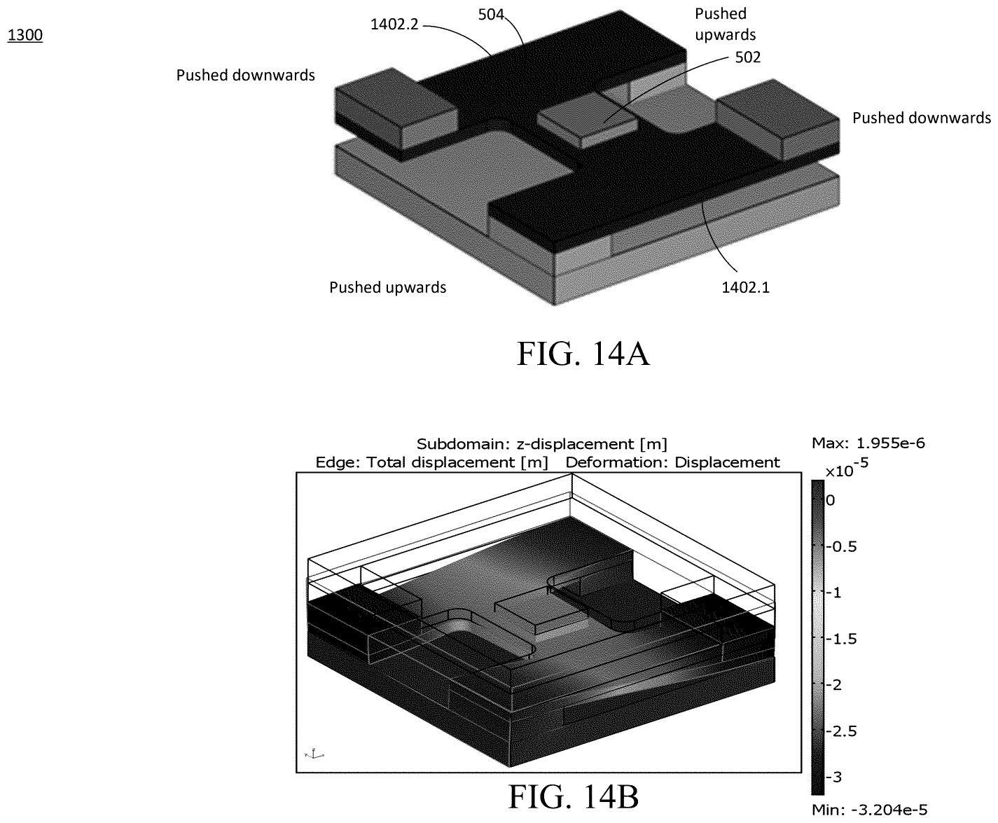

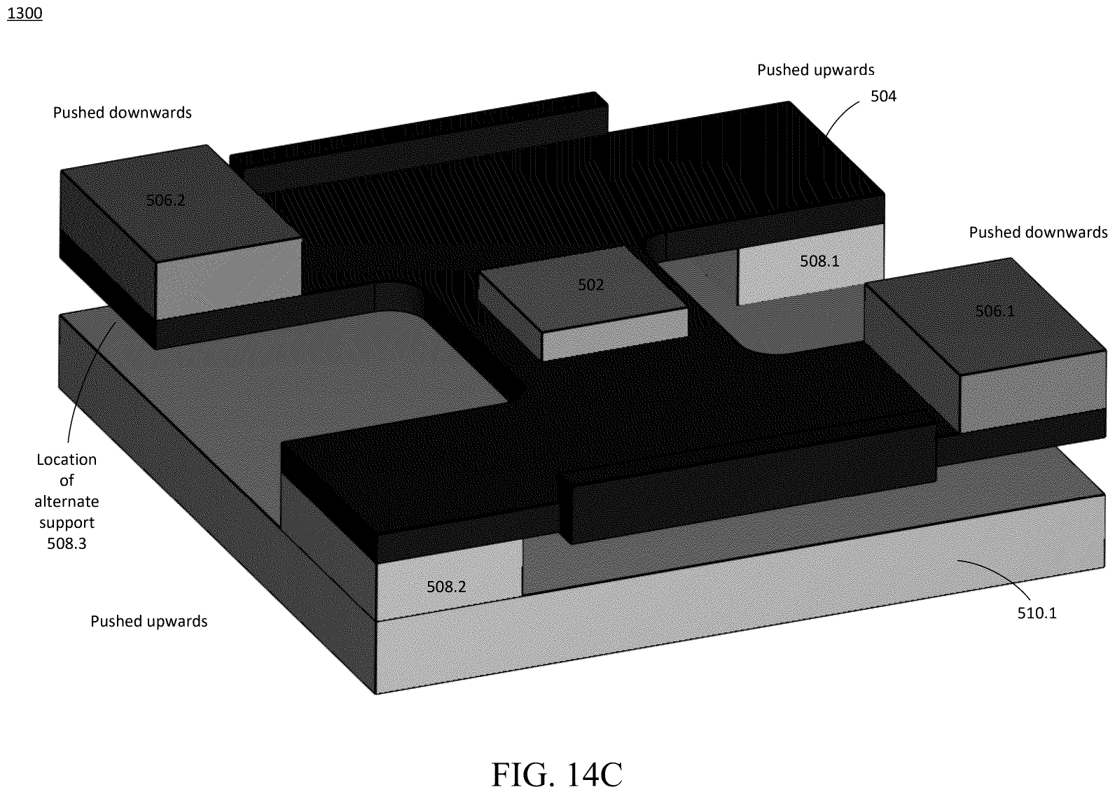

To provide additional examples, the deformation body 504 may comprise an H-shape, as discussed further below with respect to FIGS. 14A-14C. The H-shape is topologically similar to the cross shape, although two opposite notches are made larger whereas the other two are absent. Hence, the H-shape comprises 180° rotational symmetry compared to the 90° rotational symmetry of the cross shape as shown in FIGS. 5A and 5B. FIG. 14B illustrates an FEM numerical simulation of the H-shaped deformation body 504 as shown in FIG. 14A, which indicates the force transferred to the H-shaped deformation body 504 in response to an applied force in the −z direction, as discussed herein.

Additionally, it is noted that the H-shaped deformation body 504 comprises two longitudinal edges 1402.1, 1402.2, as shown in FIG. 14A. In an alternate embodiment, the H-shaped deformation body 504 may be reinforced by bending the H-shaped deformation body 504 out of plane along these two longitudinal edges 1402.1, 1402.2, as shown in FIG. 14C. This modification makes the H-shaped deformation body 504 have less deflection for the same amount of shear stress on the force sensor chip 502.

Additionally or alternatively, the H-shaped deformation body 504 may be further modified to adjust the implementation of any of the supports 506.1, 506.2, 508.1, 508.2. For example, and with continued reference to FIG. 14C, the support 506.2 may be replaced with a support that is oriented in the same manner as one of the supports 508.1, 508.2 (not shown). In other words, the support 506.2 may be replaced with a separate support 508.3 disposed on the opposite side of the H-shaped deformation body 504 with respect to the support 506.2, as indicated in FIG. 14C. The H-shaped deformation body 504 modified in this way may be mechanically coupled to the support 508.3 in any suitable manner, but be mechanically decoupled from the other supports 508.1, 508.2. Thus, H-shaped deformation body 504 may rest on supports 508.1, 508.2 with the ability to glide laterally. In such a configuration is it noted that a force applied in the −z direction couples to the H-shaped deformation body 504 only via the support 508.3, i.e. the force couples onto the H-shaped deformation body 504 only at a single location.

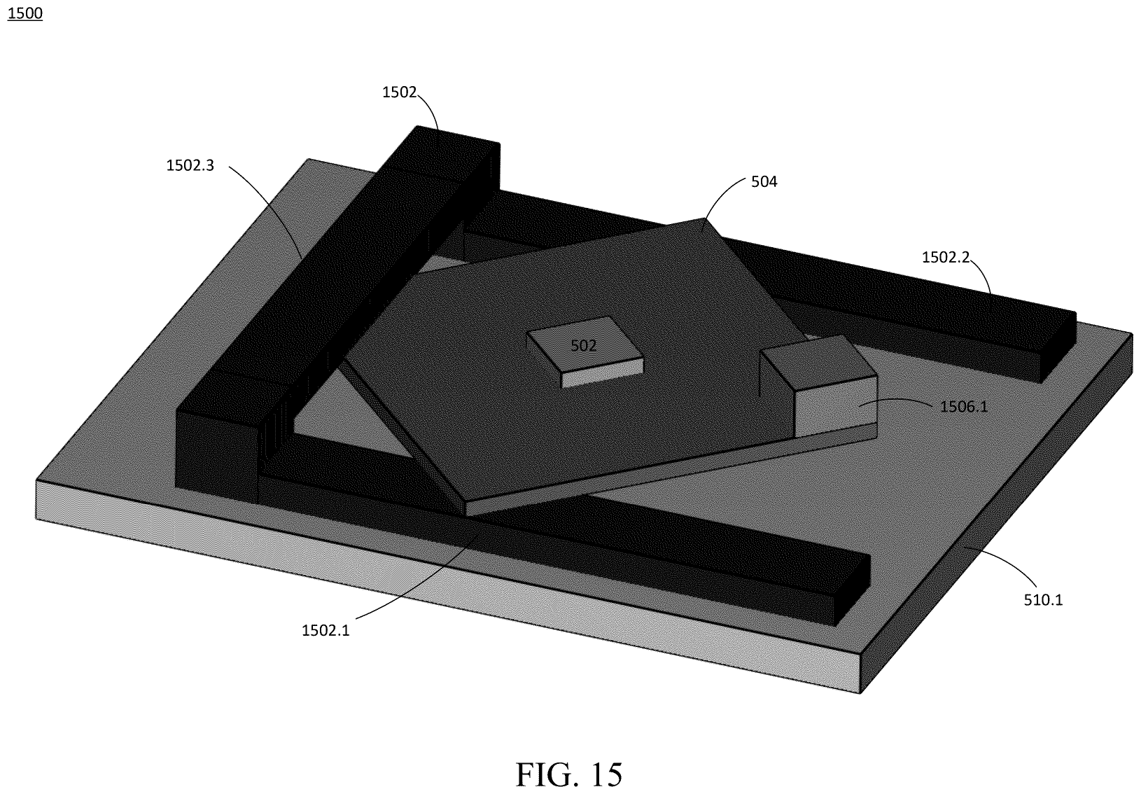

To provide additional examples, instead of the supports 506.1, 506.2, 508.1, 508.2, the deformation body 504 may implement a single support 1506.1, which may be arranged with respect to the deformation body 504 and the upper housing 510.2 in accordance with any of the techniques as discussed herein with respect to the supports 506.1, 506.2. Thus, and as one example, the force sensor package 500 may implement a U-shaped deformation body 1502, which may comprise a wire or spring-wire, for example, as shown in FIG. 15, and which may be mechanically coupled to the lower housing 510.1. The U-shaped deformation body 1502 may comprise two legs 1502.1, 1502.2, which may pass underneath the deformation body 504, which is square shaped in this example, but may be any other suitable shape, while a central leg 1502.3 of the deformation body 1502 passes above the deformation body 504. In this implementation, either the deformation body 504 or the U-shaped deformation body 1502 may be bent out of the plane.

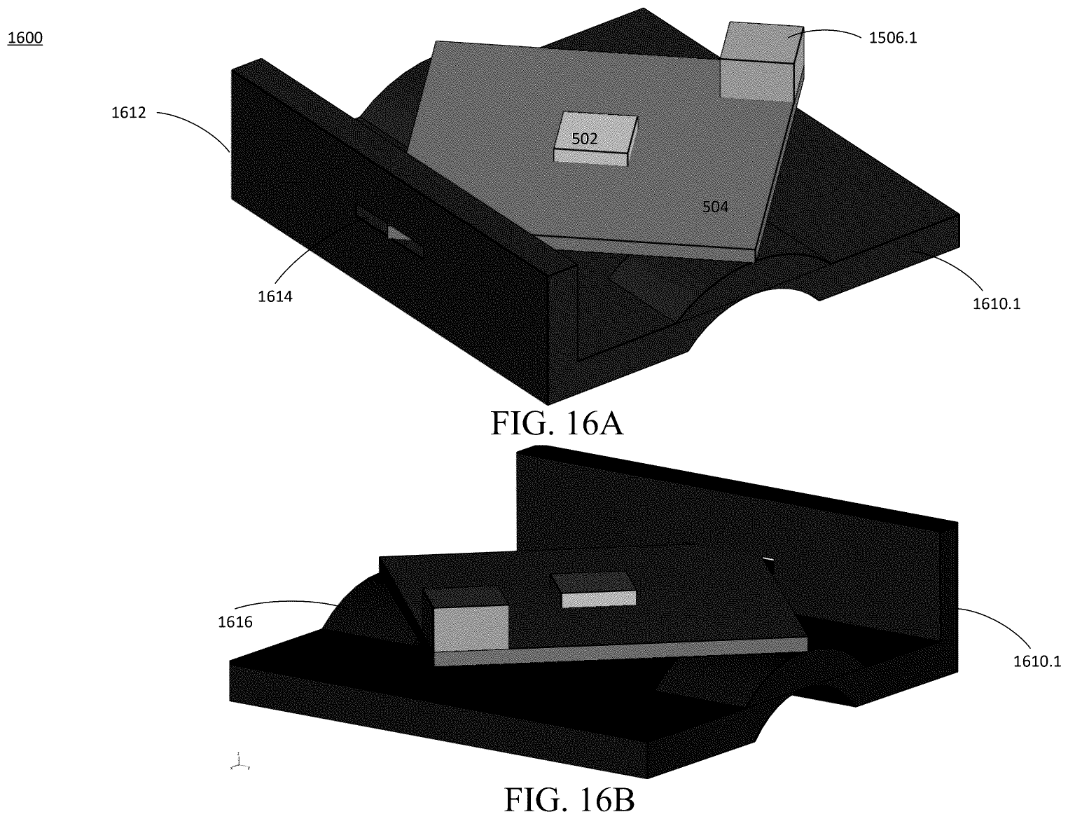

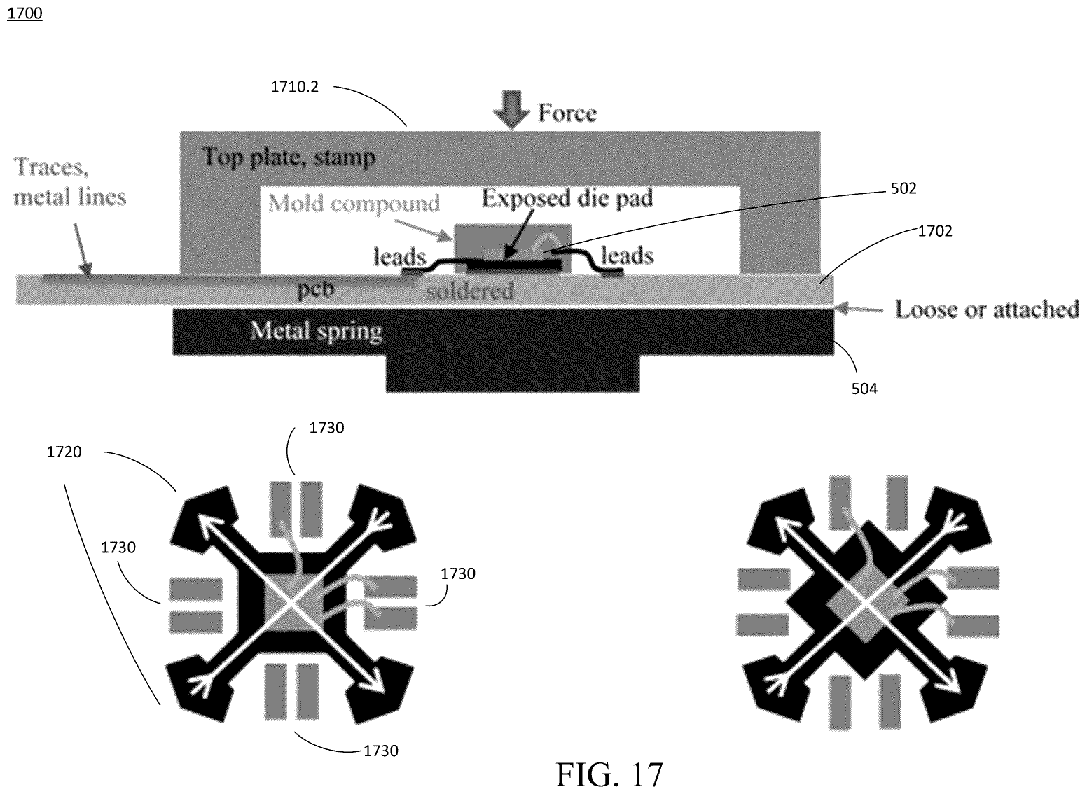

Additionally or alternatively, and referring now to FIGS. 16A-16B, the lower housing 510.1 may be implemented as any suitable type of material, such as sheet metal, for instance, and have protrusions replacing the any of the supports 508.1, 508.2, 508.3 as discussed herein (not shown). In this configuration, the lower housing 510.1 may be replaced with the lower housing 1610.1 as shown in FIGS. 16A-16B. The lower housing 1610.1 may comprise a vertical wall 1612 including a slot 1614 on one side as shown, into which the deformation body 504 is inserted. This slot 1614 functions to clamp the deformation body 504 and causes a resistance of movement of the deformation body 504 in the +z or −z direction if a force presses the right side of the deformation body 504 down at the support 1506.1.

Additionally or alternatively, instead of protrusions in the lower housing 510.1, a cylindrical deformation body 1616 (e.g. a wire) may be implemented from one corner of the deformation body 504 to the opposite one (e.g. along the line of the former protrusions). As shown in FIGS. 16A-16B, this cylindrical wire may be bent slightly (e.g. 20 μm) downwards in the central portion to avoid mechanical contact with the deformation body 504 underneath the force sensor chip 502.

Additionally or alternatively, instead of the cylindrical deformation body 1616 running diagonally underneath the central portion of the force sensor chip 502 from one corner of the to the opposite one, the deformation body 504 may rest on two spheres placed underneath these opposite corners of the deformation body 504 (not shown). These spheres (e.g. from ball bearings) may be for example press-fitted or glued into holes of the lower housing 510.1 to ensure accurate positioning.

Additionally, it may be particularly advantageous to use a substrate (e.g. a printed circuit board, PCB) made of FR4 or similar materials, which may comprise metal traces that enable electrical contact with the force sensor chip 502. For instance, instead of mounting the force sensor chip 502 directly to the deformation body 504, embodiments include assembling the force sensor chip in a package (e.g. an SMD type package with exposed die pad and peripheral leads) and mounting the force sensor package 500 on top of a substrate. An example of such an embodiment is shown in FIG. 17, which illustrates a force sensor module 1700 that may operate in a similar manner as the force sensor package 500 as discussed herein. However, the force sensor module 1700 includes a substrate 1702, which is a PCB in this example. The substrate 1702 may be disposed on the deformation body 504 in this example, and the force sensor package is mounted on the substrate 1702 and coupled to the deformation body 504 via the substrate 1702 as shown. The force sensor package may therefore comprise, in this scenario, the force sensor chip 502, a mold compound, and the various leads, bond wires, etc., as shown in FIG. 17 and further discussed below.

In the example embodiment as shown in FIG. 17, the force sensor package may be coupled to the substrate 1702 using any suitable techniques, including known techniques. For instance, the force sensor package may be coupled to the substrate 1702 using adhesives and/or solder, and inside the force sensor package the force sensor chip 502 may be mounted face-up or face-down (flip-chip). A top plate 1710.2 may then be mounted to the substrate 1702, which may serve the same purpose as the upper housing 510.2 as discussed herein. This arrangement may be particularly well-suited for force sensor applications that implement large full-scale force in excess of 100 N. This is because, in such scenarios, the primary component of the composite stiffness is defined by the deformation body 504, whereas the other portions of the force sensor module 1700 (e.g. the substrate 1702 and the force sensor chip 502) are comparably more compliant. That is, because the substrate material and the other portions of the force sensor module 1700 have less well-defined mechanical properties (stiffness, Young's modulus, Poisson number) and are more prone to manufacturing tolerances and environmental influence like temperature and humidity, the overall stiffness of the composite structure is predominantly defined by the deformation body 504.

A mold compound or any other suitable techniques may also be implemented to encapsulate the force sensor chip 502 as well as any bond wires, etc., to form the force sensor package. The force sensor package may also be encapsulated via the use of the top plate 1710.2 as shown. The encapsulation of the force sensor package in this manner may be beneficial to protect the force sensor chip 502 from dust, humidity, light exposure, mechanical failures (breakage of the bond wires), etc. The mechanical coupling between the substrate 1702 and the force sensor package may implement, for example, any suitable bonding techniques such as adhesives to glue the molded force sensor package to the substrate 1702, soldering one or more exposed die pads to the substrate 1702 (e.g. hard or soft soldering). This may also include for instance soldering bumps and balls on a bottom surface of a flip-chip of the force sensor package to the substrate 1702 and soldering leads all around the perimeter of the force sensor package to the substrate 1702.

Additionally or alternatively, for better mechanical coupling, more bumps, balls, and/or leads may be implemented than necessary to provide an electrical connection. For instance, a subset of the bumps, balls, and/or leads may provide mechanical coupling only. It may be particularly useful, for instance, to arrange such bumps, balls, and/or leads symmetrically (e.g. over the full contact surface of the force sensor package or along an entire perimeter) to ensure isotropic strain from CTE-mismatch between the force sensor package and the substrate 1702. Additionally or alternatively, embodiments include the substrate 1702 having a different lateral shape than the deformation body 504, e.g., the substrate 1702 may have an additional trace to route electrical traces off the force sensor package and to connect one end to a mating socket.

For instance, the force sensor package may have a corresponding lead frame as shown in the lower two drawings in FIG. 17, for example. The lead frame may comprise a first type of leads 1720 (in black) near the four corners of the force sensor package 1700, which are not cut off the die paddle, and a second type of leads 1730 (in gray) in-between the first type of leads 1720, which are cut off the die paddle and which are used to make electrical connections to the force sensor chip 502. The first type of leads 1720 may be used to establish a better mechanical coupling between the force sensor package and the substrate 1702, e.g. near the corners of the force sensor package as shown, where the large shear strain couples in. This lead frame may also be 90° rotationally symmetric so as not to destroy the strain pattern from the deformation body 504 onto the force sensor package, and the traces on the substrate 1702 may be likewise symmetric. This is shown in the left drawing of FIG. 17. Additionally, if the force sensor chip 502 is rotated by 45° with respect to the deformation body 504, the stress components are sigXX−sigYY (biaxial normal stress components). In this case, the black anchor pins of the first type of leads 1720 also rotate, and the pins for the electrical connection rotate as well. This is shown in the right drawing of FIG. 17, which illustrates the use of slightly longer bond wires.

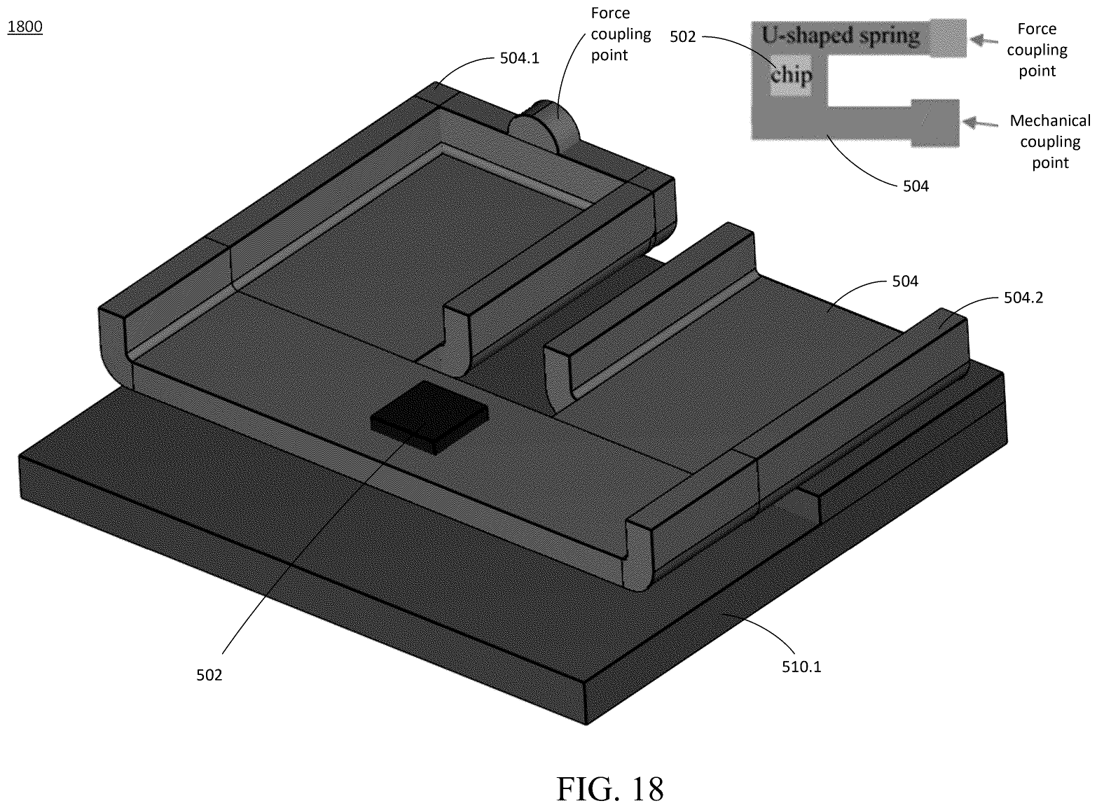

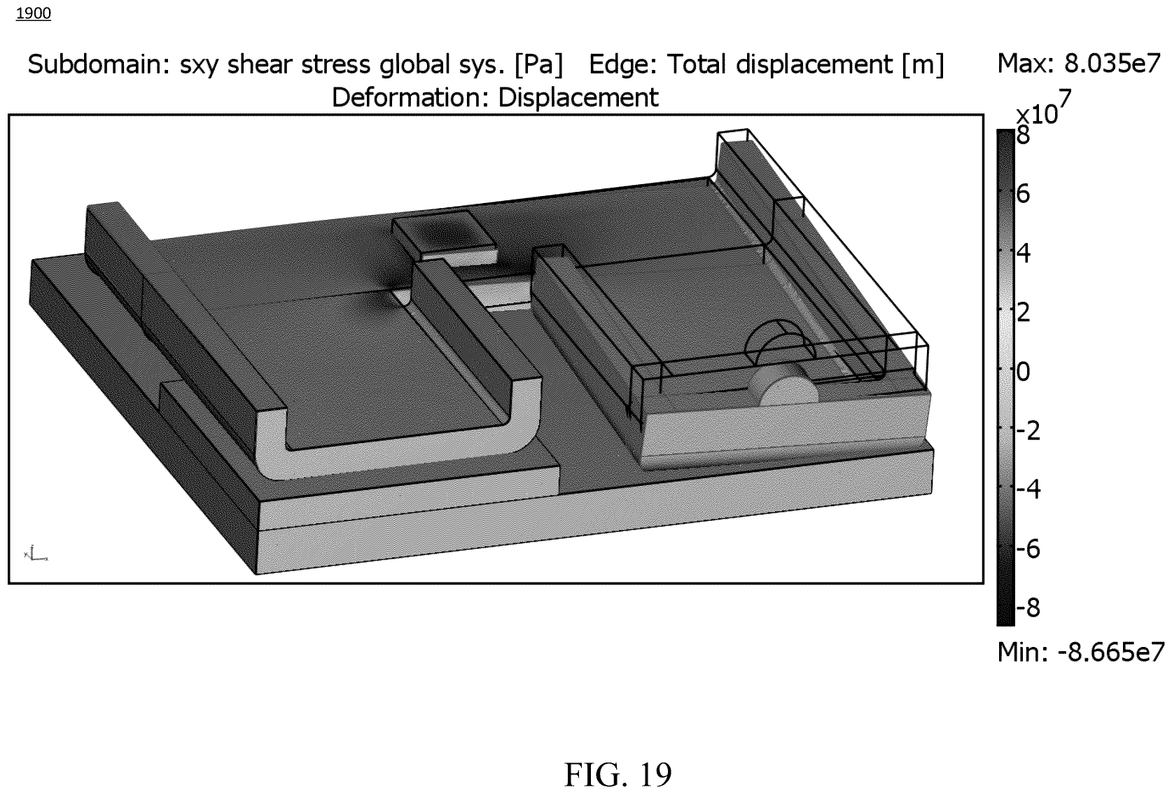

Additionally, the embodiments described herein may facilitate the measurement of other stress-components in addition to shear stress. To do so, and to provide an additional example, the deformation body 504 may comprise a U-shape, as discussed further below with respect to FIGS. 18-19. The force sensor chip 502 may be mechanically coupled to a central part the U-shaped deformation body 504 (e.g. via adhesive or other suitable bonding processes as noted herein), such as glued, soldered, attached with glass frit, etc.). The U-shaped deformation body 504 as shown in FIGS. 18-19 may comprise two arms 504.1, 504.2, with one arm (e.g. 504.2) being mechanically coupled to the lower housing 510.1 at its distal end as shown. The other arm (e.g. arm 504.1) may include a force coupling point at its distal end, which may include the protrusion as shown or any suitable support structure, such as any of those discussed herein. The deformation body 504 may be biased such that the mechanical coupling of the arm 504.2 to the lower housing 510.1 in this manner pushes the distal end of the arm 504.1 out of plane.

In this way, an applied force generates sigXX and sigYY in addition to sigXY on the force sensor chip 502 (e.g. if the x-y-axes are parallel to the chip edges as discussed above). Thus, a force may be applied in the −z direction to the end of the 504.1 of the U-shaped deformation body 504.

As one illustrative example, the force sensor chip 502 may have a size of 1 mm×1 mm×0.2 mm (x-y-axes parallel to the chip edges). The U-shaped deformation body 504 may be 0.4 mm thick, and the central part of the U-shaped deformation body 504 may be 2 mm wide. The arms 504.1, 504.2 of the U-shaped deformation body 504 may be 4 mm long.

The center part of the U-shaped deformation body 504 is therefore under torsion and bending action due to an applied force in the −z direction. The bending generates in-plane normal stress components (sigXX, sigYY). Also, the CTE-mismatch between the U-shaped deformation body 504 material and the force sensor chip 502 generates in-plane normal stress components. Conversely, the torsion provokes in-plane shear stress sigXY on the force sensor chip 502. Thus, the stress sensor elements on the force sensor chip 502 may include a shear-stress sensor to discriminate the force from thermal stress. Continuing this example, a force of IN gives a shear stress of sigXY=55 MPa at the top and center of the force sensor chip 502. The deflection of the U-shaped deformation body 504 is approximately 0.1 mm at this applied force.

Thus, it can be observed that despite the thick the U-shaped deformation body 504 (e.g. 0.4 mm) the U-shaped deformation body 504 has a fairly small stiffness. Therefore, this type of deformation body geometry is well-suited for the measurement of small forces (IN). An advantage of this deformation body geometry is also that the force sensor chip 502 moves very little compared to the arm of the U-shaped deformation body 504 where the force is applied. This protects the delicate bond wires that establish the electrical connection between the force sensor chip 502 and the leads of the force sensor package. These leads may be placed at any suitable location, such as for instance the central portion of the U-shaped deformation body 504, fixed to the lower housing 510.1, etc. Alternatively, embodiments include attaching the leads to the central portion of the U-shaped deformation body 504 via a molded body, such as those used for conventional plastic encapsulated packages. In this scenario, the leads should be not too short, because otherwise the leads will be slightly deformed due to the action of the applied force. FIG. 19 illustrates a FEM numerical simulation of the deformation and of the stress components generated for this example scenario.

### Examples

The techniques of this disclosure may also be described in the following examples.

Example 1. A sensor package configured to be coupled to an object that is subjected to mechanical deformation, the sensor package comprising: a force sensor configured to generate a force measurement signal resulting from a strain that is transferred to the sensor package as a result of a deformation of the object due to an applied force; a temperature sensor configured to generate a temperature measurement signal indicative of a temperature of a region of the sensor package that is proximate to the force sensor; and processing circuitry configured to: generate temperature-corrected force measurement data that compensates for temperature error introduced into the force measurement signal based upon the temperature measurement signal; and generate, from the temperature-corrected force measurement data, force measurement data indicative of the applied force.

Example 2. The sensor package of Example 1, wherein the sensor package comprises a monolithic integrated circuit (IC).

Example 3. The sensor package of any combination of Examples 1-2, wherein the force measurement signal and the temperature measurement signal are analog signals, and further comprising: an analog to digital converter (ADC) configured to convert the force measurement signal and the temperature measurement signal to respective digital signals, which are coupled to the processing circuitry.

Example 4. The sensor package of any combination of Examples 1-3, wherein the force sensor is mechanically coupled to the sensor package via glass fritting.

Example 5. The sensor package of any combination of Examples 1-4, further comprising: a data interface coupled to the processing circuitry; and one or more bond pads coupled to the data interface and to an external computing device, wherein the processing circuitry is configured to transmit the force measurement data to the external computing device via the data interface.

Example 6. The sensor package of any combination of Examples 1-5, wherein the one or more bond pads are coupled to a printed circuit board (PCB) via one or more corresponding bond balls, the PCB comprising one or more connections to the external computing device.

Example 7. The sensor package of any combination of Examples 1-6, wherein the one or more bond pads are coupled to a printed circuit board (PCB) via one or more corresponding bond wires, the PCB comprising one or more connections to the external computing device.

Example 8. The sensor package of any combination of Examples 1-7, wherein the sensor package is at least partially embedded within the PCB.

Example 9. The sensor package of any combination of Examples 1-8, further comprising: a non-volatile memory configured to store electrical parameters associated with the force sensor and/or the temperature sensor, wherein the processing circuitry is configured to generate the temperature-corrected force measurement data using one or more of the stored electrical parameters.

Example 10. A sensor package, comprising: a deformation body; a first and a second support, each of the first and second support being disposed at respective locations of the deformation body that are opposite to one another with respect to a first line of symmetry of the deformation body; a third and a fourth support, each of the third and the fourth support being disposed at respective locations of the deformation body that are opposite to one another with respect to a second line of symmetry of the deformation body, the first and the second lines of symmetry being different from one another; and a force sensor chip coupled to the deformation body and configured to generate one or more measurement signals resulting from an applied force that deforms the deformation body, wherein the applied force is distributed to the deformation body via the first, the second, the third, and the fourth supports.

Example 11. The sensor package of Example 10, wherein the deformation body, the force sensor chip, and the first, the second, the third, and the fourth supports are configured to generate, as a result of the coupling between the force sensor chip and the deformation body, normal stresses in two orthogonal directions in the force sensor chip having different values in response to the applied force.

Example 12. The sensor package of any combination of Examples 10-11, wherein the force sensor chip is coupled directly to the deformation body and is disposed at a center of the deformation body.

Example 13. The sensor package of any combination of Examples 10-12, further comprising: a printed circuit board (PCB) disposed on the deformation body, wherein the force sensor chip is mounted on the PCB and coupled to the deformation body via the PCB.

Example 14. The sensor package of any combination of Examples 10-13, further comprising: an upper housing disposed at a first side of the deformation body; and a lower housing disposed at a second side of the deformation body that is opposite to the first side, wherein one of the first and the second supports is mechanically coupled to the upper housing, and wherein one of the third and the fourth supports is mechanically coupled to the lower housing.

Example 15. The sensor package of any combination of Examples 10-14, further comprising: an upper housing disposed at a first side of the deformation body and mechanically decoupled from the deformation body; and a lower housing disposed at a second side of the deformation body that is opposite to the first side, wherein the first and the second supports are part of the upper housing such that the upper housing and the first and second supports form a unitary component, and wherein one of the third and the fourth supports is mechanically coupled to the lower housing.

Example 16. The sensor package of any combination of Examples 10-15, wherein the force sensor chip comprises an orthogonal metal oxide semiconductor field effect transistor (MOSFET) current mirror or a pair of orthogonal resistors.

Example 17. The sensor package of any combination of Examples 10-16, wherein the force sensor chip comprises two sensor elements, and wherein each of the two sensor elements has a respective electrical parameter that responds differently to orthogonal in-plane stress components induced into the deformation body due to the applied force.

Example 18. The sensor package of any combination of Examples 10-17, wherein the force sensor chip comprises two sensor elements that are disposed perpendicular to one another.

Example 19. The sensor package of any combination of Examples 10-18, wherein the force sensor chip is disposed on the deformation body such that the one or more measurement signals are indicative of a measurement of in-plane stress components.

Example 20. The sensor package of any combination of Examples 10-19, further comprising: an electronic circuit configured to generate a force measurement signal from the one or more measurement signals, the force measurement signal being indicative of the applied force.

Example 21. The sensor package of any combination of Examples 10-20, wherein the force sensor chip comprises a first and a second crystallographic axis from among a set of <100> directions, each being respectively aligned with the first and the second lines of symmetry of the deformation body.

Example 22. The sensor package of any combination of Examples 10-21, wherein the force sensor chip comprises a first and a second crystallography axis from among a set of <100> directions, each being respectively rotated by 45 degrees from the first and the second lines of symmetry of the deformation body.

Example 23. The sensor package of any combination of Examples 10-22, wherein the deformation body comprises a planar spring having a cross shape with four arms of equal length, and wherein each one of the first, second, third, and fourth supports is disposed at a distal end of each respective one of the four arms.

Example 24. The sensor package of any combination of Examples 10-23, further comprising: an upper housing disposed at a first side of the planar spring; a lower housing disposed at a second side of the planar spring that is opposite to the first side; and one or more bond wires coupled to the force sensor chip, wherein the one or more bond wires are routed between at least one pair of adjacent arms of the four arms of the planar spring.

Example 25. The sensor package of any combination of Examples 10-24, wherein the first, the second, the third, and the fourth supports are part of the deformation body such that the deformation body and the first, the second, the third, and the fourth supports form a unitary component.

Example 26. A sensor package, comprising: a deformation body; a force sensor chip coupled to the deformation body; an electronic circuit; and at least one force coupler configured to induce stress into the deformation body due to an applied force that deforms the deformation body, wherein the force sensor chip is configured to generate one or more measurement signals resulting from the induced stress in the deformation body, and wherein the electronic circuit configured to generate a force measurement signal from the one or more measurement signals, the force measurement signal being indicative of the applied force.

Example 27. The sensor package of Example 26, wherein the force sensor chip is coupled directly to the deformation body and is disposed at a center of the deformation body.

Example 28. The sensor package of any combination of Examples 26-27, wherein the deformation body comprises a planar spring.

Example 29. The sensor package of any combination of Examples 26-28, wherein the planar spring comprises a spiral, a U-shape, or an H-shape.

Example 30. The sensor package of any combination of Examples 26-29, wherein the force sensor chip comprises an orthogonal metal oxide semiconductor field effect transistor (MOSFET) current mirror or a pair of orthogonal resistors.

### CONCLUSION

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation data. The term “information” may in addition to any form of digital information also include other forms of representing information. The term “entity” or “unit” may in embodiments include any device, apparatus circuits, hardware, software, firmware, chips, or other semiconductors as well as logical units or physical implementations of protocol layers etc. Furthermore, the terms “coupled” or “connected” may be interpreted in a broad sense not only covering direct but also indirect coupling.

It is further to be noted that methods disclosed in the specification or in the claims may be implemented by a device having means for performing each of the respective steps of these methods.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This disclosure is intended to cover any adaptations or variations of the specific embodiments discussed herein.

What is claimed is:

1. A sensor package configured to be coupled to an object that is subjected to mechanical deformation, the sensor package comprising:
a force sensor configured to generate a force measurement signal resulting from a strain that is transferred to the sensor package as a result of a deformation of the object due to an applied force;
a temperature sensor configured to generate a temperature measurement signal indicative of a temperature of a region of the sensor package that is proximate to the force sensor; and
processing circuitry configured to:
generate temperature-corrected force measurement data that compensates for temperature error introduced into the force measurement signal based upon the temperature measurement signal; and
generate, from the temperature-corrected force measurement data, force measurement data indicative of the applied force.

2. The sensor package of claim 1, wherein the sensor package comprises a monolithic integrated circuit (IC).

3. The sensor package of claim 1, wherein the force measurement signal and the temperature measurement signal are analog signals, and further comprising:
an analog to digital converter (ADC) configured to convert the force measurement signal and the temperature measurement signal to respective digital signals, which are coupled to the processing circuitry.

4. The sensor package of claim 1, wherein the force sensor is mechanically coupled to the sensor package via glass fritting.

5. The sensor package of claim 1, further comprising:
a data interface coupled to the processing circuitry; and
one or more bond pads coupled to the data interface and to an external computing device,
wherein the processing circuitry is configured to transmit the force measurement data to the external computing device via the data interface.

6. The sensor package of claim 5, wherein the one or more bond pads are coupled to a printed circuit board (PCB) via one or more corresponding bond balls, the PCB comprising one or more connections to the external computing device.

7. The sensor package of claim 5, wherein the one or more bond pads are coupled to a printed circuit board (PCB) via one or more corresponding bond wires, the PCB comprising one or more connections to the external computing device.

8. The sensor package of claim 7, wherein the sensor package is at least partially embedded within the PCB.

9. The sensor package of claim 1, further comprising:
a non-volatile memory configured to store electrical parameters associated with the force sensor and/or the temperature sensor,
wherein the processing circuitry is configured to generate the temperature-corrected force measurement data using one or more of the stored electrical parameters.

10. A sensor package, comprising:
a deformation body;
a first and a second support, each of the first and second support being disposed at respective locations of the deformation body that are opposite to one another with respect to a first line of symmetry of the deformation body;
a third and a fourth support, each of the third and the fourth support being disposed at respective locations of the deformation body that are opposite to one another with respect to a second line of symmetry of the deformation body, the first and the second lines of symmetry being different from one another; and
a force sensor chip coupled to the deformation body and configured to generate one or more measurement signals resulting from an applied force that deforms the deformation body,
wherein the applied force is distributed to the deformation body via the first, the second, the third, and the fourth supports.

11. The sensor package of claim 10, wherein the deformation body, the force sensor chip, and the first, the second, the third, and the fourth supports are configured to generate, as a result of the coupling between the force sensor chip and the deformation body, normal stresses in two orthogonal directions in the force sensor chip having different values in response to the applied force.

12. The sensor package of claim 10, wherein the force sensor chip is coupled directly to the deformation body and is disposed at a center of the deformation body.

13. The sensor package of claim 10, further comprising:
a printed circuit board (PCB) disposed on the deformation body,
wherein the force sensor chip is mounted on the PCB and coupled to the deformation body via the PCB.

14. The sensor package of claim 10, further comprising:
an upper housing disposed at a first side of the deformation body; and
a lower housing disposed at a second side of the deformation body that is opposite to the first side,
wherein one of the first and the second supports is mechanically coupled to the upper housing, and
wherein one of the third and the fourth supports is mechanically coupled to the lower housing.

15. The sensor package of claim 10, further comprising:
an upper housing disposed at a first side of the deformation body and mechanically decoupled from the deformation body; and
a lower housing disposed at a second side of the deformation body that is opposite to the first side,
wherein the first and the second supports are part of the upper housing such that the upper housing and the first and second supports form a unitary component, and
wherein one of the third and the fourth supports is mechanically coupled to the lower housing.

16. The sensor package of claim 10, wherein the force sensor chip comprises an orthogonal metal oxide semiconductor field effect transistor (MOSFET) current mirror or a pair of orthogonal resistors.

17. The sensor package of claim 10, wherein the force sensor chip comprises two sensor elements, and
wherein each of the two sensor elements has a respective electrical parameter that responds differently to orthogonal in-plane stress components induced into the deformation body due to the applied force.

18. The sensor package of claim 10, wherein the force sensor chip comprises two sensor elements that are disposed perpendicular to one another.

19. The sensor package of claim 10, wherein the force sensor chip is disposed on the deformation body such that the one or more measurement signals are indicative of a measurement of in-plane stress components.

20. The sensor package of claim 10, further comprising:
an electronic circuit configured to generate a force measurement signal from the one or more measurement signals, the force measurement signal being indicative of the applied force.

21. The sensor package of claim 10, wherein the force sensor chip comprises a first and a second crystallographic axis from among a set of <100> directions, each being respectively aligned with the first and the second lines of symmetry of the deformation body.

22. The sensor package of claim 10, wherein the force sensor chip comprises a first and a second crystallography axis from among a set of <100> directions, each being respectively rotated by 45 degrees from the first and the second lines of symmetry of the deformation body.

23. The sensor package of claim 10, wherein the deformation body comprises a planar spring having a cross shape with four arms of equal length, and
wherein each one of the first, second, third, and fourth supports is disposed at a distal end of each respective one of the four arms.

24. The sensor package of claim 23, further comprising:
an upper housing disposed at a first side of the planar spring;
a lower housing disposed at a second side of the planar spring that is opposite to the first side; and
one or more bond wires coupled to the force sensor chip,
wherein the one or more bond wires are routed between at least one pair of adjacent arms of the four arms of the planar spring.

25. The sensor package of claim 10, wherein the first, the second, the third, and the fourth supports are part of the deformation body such that the deformation body and the first, the second, the third, and the fourth supports form a unitary component.

26. A sensor package, comprising:
a deformation body;
a force sensor chip coupled to the deformation body;
an electronic circuit; and
at least one force coupler configured to induce stress into the deformation body due to an applied force that deforms the deformation body,
wherein the force sensor chip is configured to generate one or more measurement signals resulting from the induced stress in the deformation body, and
wherein the electronic circuit configured to generate a force measurement signal from the one or more measurement signals, the force measurement signal being indicative of the applied force.

27. The sensor package of claim 26, wherein the force sensor chip is coupled directly to the deformation body and is disposed at a center of the deformation body.

28. The sensor package of claim 26, wherein the deformation body comprises a planar spring.

29. The sensor package of claim 28, wherein the planar spring comprises a spiral, a U-shape, or an H-shape.

30. The sensor package of claim 26, wherein the force sensor chip comprises an orthogonal metal oxide semiconductor field effect transistor (MOSFET) current mirror or a pair of orthogonal resistors.
